(19) United States
(12) Patent Application Publication
(10) Pub. No.: US 2025/0106710 A1
(43) Pub. Date: Mar. 27, 2025

(54) SERVICE CONTINUITY OF BISTATIC UE-ASSISTED SENSING SERVICES

(71) Applicant: Nokia Technologies Oy, Espoo (FI)

(72) Inventors: Hideaki TAKAHASHI, Tokyo (JP); Apostolos KOUSARIDAS, Munich (DE); Pallab GUPTA, Bangalore (IN); Shubhranshu SINGH, Munich (DE); André NOLL BARRETO, Massy (FR)

(21) Appl. No.: 18/826,918

(22) Filed: Sep. 6, 2024

(30) Foreign Application Priority Data
Sep. 22, 2023 (GB) 2314555.0

(51) Int. Cl. H04W 36/00; H04W 24/10

(52) U.S. Cl. CPC H04W 36/00833; H04W 36/0011; H04W 24/10

(57) ABSTRACT

A method includes: operating, by a source radio access network (RAN) node serving a user equipment (UE), in a bistatic mode for a sensing service provided by one or more components of a core network; and based on a handover decision that switches the UE to a target RAN node, transmitting, by the source RAN node, sensing service information to one of the following: the target RAN node, or an access and mobility management function (AMF) of the core network. The sensing service information includes at least one of the following: at least one sensing session identifier corresponding to at least one sensing session for the serving service, a sensing resource configuration for the sensing service, a sensing session configuration for the sensing service, or a sensing data reporting configuration for the sensing service.

### CROSS REFERENCE TO RELATED APPLICATIONS

This application claims the benefit of Great Britain Patent Application No. 2314555.0, filed Sep. 22, 2023, which is incorporated by reference herein in its entirety.

### FIELD

Various example embodiments relate generally to wireless networks and, more particularly, to continuity of a sensing service due to mobility.

### BACKGROUND

Wireless networking provides significant advantages for user mobility. A user's ability to remain connected while on the move provides advantages not only for the user, but also provides greater efficiency and productivity for society as a whole. As user expectations for connection reliability, processing power, data speed, and device battery life, become more demanding, technology for wireless networking must also keep pace with such expectations. Additionally, widespread geographic coverage provided by wireless networking infrastructure and user equipment may provide new opportunities for new technical innovations to serve widespread geographies. Accordingly, there is continuing interest in improving wireless networking technology and services.

### SUMMARY

In accordance with aspects of the disclosure, a method includes operating, by a source radio access network (RAN) node serving a user equipment (UE), in a bistatic mode for a sensing service provided by one or more components of a core network; and based on a handover decision that switches the UE to a target RAN node, transmitting, by the source RAN node, sensing service information to one of the following: the target RAN node, or an access and mobility management function (AMF) of the core network. The sensing service information includes at least one of the following: at least one sensing session identifier corresponding to at least one sensing session for the serving service, a sensing resource configuration for the sensing service, a sensing session configuration for the sensing service, or a sensing data reporting configuration for the sensing service.

In an aspect of the method, the method may further include receiving, by the source RAN node, sensing continuity information including at least one of the following: an indication of whether each of at least one sensing session was accepted or not accepted by a sensing admission control procedure, an update for the sensing resource configuration, an update for the sensing session configuration, or an update for the sensing data reporting configuration.

In an aspect of the method, the transmitting the sensing service information includes transmitting the sensing service information in a handover request message.

In an aspect of the method, the receiving the sensing continuity information may include receiving the sensing continuity information in a handover request acknowledgment message from target RAN node.

In an aspect of the method, the transmitting the sensing service information may include transmitting the sensing service information in a message indicating that handover is required.

In an aspect of the method, the receiving the sensing continuity information may include receiving the sensing continuity information in a handover command message from the AMF.

In an aspect of the method, the method may further include buffering sensed data from operating in the bistatic mode and transmitting the sensed data to the target RAN node.

In accordance with aspects of the disclosure, a source radio access network (RAN) node includes at least one processor; and at least one memory storing instructions which, when executed by the at least one processor, causes the source RAN node at least to perform a method as in any of the preceding claims.

In accordance with aspects of the disclosure, a method includes receiving, by a target radio access network (RAN) node of a handover decision, sensing service information for a sensing service, the sensing service provided by one or more components of a core network, the sensing service information including at least one of the following: at least one sensing session identifier corresponding to at least one sensing session of a source RAN node of the handover decision, a sensing resource configuration, a sensing session configuration, or a sensing data reporting configuration; and operating, by the target RAN node, in a bistatic mode for the sensing service.

In an aspect of the method, the method may further include performing, by the target RAN node, sensing admission control procedure based on the sensing service information.

In an aspect of the method, the method may further include generating, by the target RAN node, based on the sensing admission control procedure, sensing continuity information including at least one of the following: an indication of whether each of the at least one sensing session was accepted or not accepted by the sensing admission control procedure, an update for the sensing resource configuration, an update for the sensing session configuration, or an update for the sensing data reporting configuration; and transmitting, by the target RAN node, the sensing continuity information.

In an aspect of the method, the receiving the sensing service information may include receiving, from the source RAN node, the sensing service information in a handover request message. The transmitting the sensing continuity information may include transmitting, to the source RAN node, the sensing continuity information in a handover request acknowledgment message.

In an aspect of the method, the receiving the sensing service information may include receiving, from an access and mobility management function (AMF) of the core network, the sensing service information in a handover request message. The transmitting the sensing continuity information may include transmitting, to the AMF, the sensing continuity information in a handover request acknowledgment message.

In an aspect of the method, the AMF may be a target AMF in case of an AMF relocation due to handover.

In an aspect of the method, the method may further include transmitting, by the target RAN node, to an access and mobility management function (AMF) of the core network, a path switch request message that includes the sensing continuity information.

In an aspect of the method, the method may further include transmitting, by the target RAN node, to an access and mobility management function (AMF) of the core network, a path switch request message including the sensing service information; and receiving, by the target RAN node, from the AMF, a path switch request acknowledgment message including the sensing continuity information, the sensing continuity information including at least one of the following: an indication of whether each of at least one sensing session was accepted or not accepted by a sensing admission control procedure, an update for the sensing resource configuration, an update for the sensing session configuration, or an update for the sensing data reporting configuration.

In an aspect of the method, the method may further include receiving, by the target RAN node, from a sensing management function (SeMF) of the one or more components of the core network, a sensing admission control procedure request acknowledgment message that includes the sensing continuity information, the sensing continuity information including at least one of the following: an indication of whether each of at least one sensing session was accepted or not accepted by a sensing admission control procedure, an update for the sensing resource configuration, an update for the sensing session configuration, or an update for the sensing data reporting configuration.

In an aspect of the method, the method may further include transmitting, by the target RAN node, to an access and mobility management function (AMF) of the core network, a handover execution notification message that includes the sensing service information.

In an aspect of the method, the method may further include receiving, by the target RAN node, from a sensing management function (SeMF) of the one or more components of the core network, a sensing session update request message that includes the sensing continuity information, the sensing continuity information including an indication of whether each of at least one sensing session was accepted or not accepted by a sensing admission control procedure; transmitting, by the target RAN node, to a user equipment (UE) served by the target RAN node, a reconfiguration of UE sensing configuration message; receiving, by the target RAN node, from the UE, a response to the reconfiguration of UE sensing configuration message; and transmitting, by the target RAN node, to the SeMF, a response to the sensing session update request message.

In an aspect of the method, the method may further include receiving, from the source RAN node, sensed data buffered by the source RAN node.

In accordance with aspects of the disclosure, a target radio access network (RAN) node includes at least one processor; and at least one memory storing instructions which, when executed by the at least one processor, causes the target RAN node at least to perform a method as in any of the preceding claims.

In accordance with aspects of the disclosure, a method includes receiving, by an access and mobility management function (AMF) of a core network, a first message relating to a handover decision for a handover from a source radio access network (RAN) node to the target RAN node. The source RAN node is utilized by a sensing service provided by a sensing management function (SeMF) of the core network; and transmitting, by the AMF, to the SeMF, a notification message indicating that the handover has occurred.

In an aspect of the method, the first message may include sensing service information of the sensing service, the sensing service information including at least one of the following: at least one sensing session identifier corresponding to at least one sensing session of the source RAN node, a sensing resource configuration, a sensing session configuration, or a sensing data reporting configuration.

In an aspect of the method, the first message is a path switch request message from the target RAN node. The method may further include receiving, by the AMF, from the SeMF, an acknowledgement of the notification message indicating that the handover has occurred; and transmitting, by the AMF, to the target RAN node, an acknowledgement of the path switch request message, wherein the acknowledgement of the notification message and the acknowledgement of the path switch request message that includes sensing continuity information, the sensing continuity information including at least one of the following: an indication of whether each of the at least one sensing session, of the source RAN node, was accepted or not accepted by a sensing admission control procedure in connection with the handover decision, an update for the sensing resource configuration, an update for the sensing session configuration or an update for the sensing data reporting configuration. In an aspect of the method, the first message is a message from the source RAN node, indicating that handover is required.

In an aspect of the method, the method may further include transmitting, by the AMF, to the target RAN node, a handover request message that includes the sensing service information.

In an aspect of the method, the method may further include receiving, by the AMF, from the target RAN node, a handover request acknowledgment message including the sensing continuity information, the sensing continuity information including at least one of the following: an indication of whether each of the at least one sensing session, of the source RAN node, was accepted or not accepted by a sensing admission control procedure in connection with the handover decision, an update for a sensing resource configuration of the sensing service, an update for a sensing session configuration of the sensing service, or an update for a sensing data reporting configuration of the sensing service; and transmit, by the AMF, to the source RAN node, a handover command message including the sensing continuity information.

In an aspect of the method, the first message may include sensing continuity information of the sensing service, the sensing continuity information including at least one of the following: an indication of whether each of at least one sensing session of the source RAN node, was accepted or not accepted by a sensing admission control procedure in connection with the handover decision, an update for a sensing resource configuration of the sensing service, an update for a sensing session configuration of the sensing service, or an update for a sensing data reporting configuration of the sensing service.

In an aspect of the method, the notification message indicating that the handover has occurred may include at least one of the following: an indication of whether each of at least one sensing session, of the source RAN node, was accepted or not accepted by a sensing admission control procedure in connection with the handover, an update for a sensing resource configuration of the sensing service, an update for a sensing session configuration of the sensing service, or an update for a sensing data reporting configuration of the sensing service.

In an aspect of the method, the notification message indicating that the handover has occurred may include at least one sensing session identifier corresponding to at least one sensing session of the source RAN node.

In an aspect of the method, the method may further include receiving, by the AMF, from the SeMF, a sensing session update request message including sensing continuity information; transmitting, by the AMF, to the target RAN node, the sensing session update request message including the sensing continuity information; receiving, by the AMF, from the target RAN node, a response to the sensing session update request message; and transmitting, by the AMF, to the SeMF, the response to the sensing session update request message. The sensing continuity information may include at least one of the following: an indication of whether each of at least one sensing session, of the source RAN node, was accepted or not accepted by a sensing admission control procedure in connection with the handover, an update for a sensing resource configuration of the sensing service, an update for a sensing session configuration of the sensing service, or an update for a sensing data reporting configuration of the sensing service.

In accordance with aspects of the disclosure, an apparatus includes at least one processor; and at least one memory storing instructions which, when executed by the at least one processor, cause the apparatus at least to perform a method as in any of the preceding claims.

In accordance with aspects of the disclosure, a method includes receiving, by a source access and mobility management function (AMF) of a core network, a first message relating to a handover decision for a handover from a source radio access network (RAN) node to the target RAN node, wherein the source RAN node is utilized by a sensing service provided by a sensing management function (SeMF) of the core network; and transmitting, by the source AMF, to a target AMF, a create user equipment (UE) context request message. The first message and the create UE context request message comprise sensing service information of the sensing service, the sensing service information including at least one of the following: at least one sensing session identifier corresponding to at least one sensing session of the source RAN node, a sensing resource configuration, a sensing session configuration, or a sensing data reporting configuration.

In an aspect of the method, the first message is a message, from the source RAN node, indicating that handover is required.

In an aspect of the method, the method may further include receiving, by the source AMF, from the target AMF, a response to the create UE context request message; and transmitting, by the source AMF, to the source RAN node, a handover command message. The response to the create UE context request message and the handover command message comprise at least one of the following: an indication of whether each of the at least one sensing session, of the source RAN node, was accepted or not accepted by a sensing admission control procedure in connection with the handover decision, an update for the sensing resource configuration, an update for the sensing session configuration or an update for the sensing data reporting configuration.

In accordance with aspects of the disclosure, an apparatus includes at least one processor; and at least one memory storing instructions which, when executed by the at least one processor, cause the apparatus at least to perform a method as in any of the preceding claims.

In accordance with aspects of the disclosure, a method includes receiving, by a target access and mobility management function (AMF) of a core network, from a source AMF, a first message relating to a handover decision for a handover from a source radio access network (RAN) node to the target RAN node, wherein the source RAN node is utilized by a sensing service provided by a sensing management function (SeMF) of the core network; and transmitting, by the target AMF, to the target RAN node, a handover request message. The first message and the handover request message comprise sensing service information of the sensing service, the sensing service information including at least one of the following: at least one sensing session identifier corresponding to at least one sensing session of the source RAN node, a sensing resource configuration, a sensing session configuration, or a sensing data reporting configuration.

In an aspect of the method, the first message may be a create user equipment (UE) context request message from the source AMF.

In an aspect of the method, the method may further include receiving, by the target AMF, from the target RAN node, a handover request acknowledgment message; and transmitting, by the target AMF, to the source AMF, a response to the create UE context request message. The handover request acknowledgment message and the response to the create UE context request message comprise sensing continuity information, the sensing continuity information including at least one of the following: an indication of whether each of the at least one sensing session, of the source RAN node, was accepted or not accepted by a sensing admission control procedure in connection with the handover decision, an update for the sensing resource configuration, an update for the sensing session configuration or an update for the sensing data reporting configuration.

In an aspect of the method, the method may further include transmitting, by the target AMF, to the SeMF, a notification message indicating that the handover has occurred.

In an aspect of the method, the notification message includes sensing continuity information, the sensing continuity information including an indication of whether each of the at least one sensing session, of the source RAN node, was accepted or not accepted by a sensing admission control procedure in connection with the handover decision,

In an aspect of the method, the notification message may include the at least one sensing session identifier corresponding to the at least one sensing session of the source RAN node.

In accordance with aspects of the disclosure, an apparatus includes at least one processor; and at least one memory storing instructions which, when executed by the at least one processor, cause the apparatus at least to perform a method as in any of the preceding paragraphs.

In accordance with aspects of the disclosure, a method includes receiving, by an access and mobility management function (AMF) of a core network, a first message indicating that a handover, from a source radio access network (RAN) node to a target RAN node, has occurred, wherein the source RAN node is utilized by a sensing service provided by a source sensing management function (SeMF) of the core network; determining, by the AMF, that the source SeMF is to be changed to a target SeMF; and transmitting, by the AMF, to the source SeMF, a second message indicating that the handover has occurred and that the source SeMF is to be changed to the target SeMF.

In an aspect of the method, the method may further include receiving, by the AMF, from the target SeMF, an acknowledgment of the second message.

In accordance with aspects of the disclosure, an apparatus includes at least one processor; and at least one memory storing instructions which, when executed by the at least one processor, cause the apparatus at least to perform a method as any of the preceding claims.

In accordance with aspects of the disclosure, a method includes providing, by a sensing management function (SeMF) of a core network, a sensing service, the sensing service including sensing service information of a source radio access network (RAN) node of a handover decision, the sensing service information including at least one of the following: at least one sensing session identifier corresponding to at least one sensing session at the source RAN node, a sensing resource configuration, a sensing session configuration, or a sensing data reporting configuration; and receiving, by the SeMF, from an access and mobility management function (AMF) of the core network, a notification message indicating that a handover for the handover decision has occurred.

In an aspect of the method, the notification message may include sensing continuity information that includes at least one of the following: an indication of whether each of at least one sensing session was accepted or not accepted by a sensing admission control procedure, an update for the sensing resource configuration, an update for the sensing session configuration, or an update for the sensing data reporting configuration.

In an aspect of the method, the notification message may include the at least one sensing session identifier corresponding to the at least one sensing session at the source RAN node.

In an aspect of the method, the method may further include based on the notification message indicating that the handover for the handover decision has occurred, performing, by the SeMF, sensing admission control procedure.

In an aspect of the method, the method may further include generating, by the SeMF, based on the sensing admission control procedure, sensing continuity information including at least one of the following: an indication of whether each of at least one sensing session was accepted or not accepted by the sensing admission control procedure, an update for the sensing resource configuration, an update for the sensing session configuration, or an update for the sensing data reporting configuration.

In an aspect of the method, the method may further include transmitting, by the SeMF, to the AMF, an acknowledgment of the notification message, the acknowledgment including the sensing continuity information.

In an aspect of the method, the method may further include transmitting, by the SeMF, to a target RAN node of the handover, a sensing admission control procedure request acknowledgment message that includes the sensing continuity information.

In an aspect of the method, the method may further include transmitting, by the SeMF, to a target RAN node of the handover, a sensing session update request message that includes the sensing continuity information; and receiving, by the SeMF, from the target RAN node, a response to the sensing session update request message.

In an aspect of the method, the notification message may further include an indication to change SeMF to a target SeMF.

In an aspect of the method, the method may further include determining, by the SeMF, to change SeMF to a target SeMF.

In an aspect of the method, the method may further include transmitting, by the SeMF, to the target SeMF, a sensing context transfer request message; and receiving, by the SeMF, from the target SeMF, a response to the sensing context transfer request message.

In accordance with aspects of the disclosure, an apparatus includes at least one processor; and at least one memory storing instructions which, when executed by the at least one processor, causes the apparatus at least to perform a method as in any of the preceding claims.

In accordance with aspects of the disclosure, a method includes receiving, by a target sensing management function (SeMF) of a core network, from a source SeMF, a sensing context transfer request message relating to a sensing service provided by the SeMF to at least one network function of the following: an application function, or a network exposure function; and transmitting, by the target SeMF, to the at least one network function, a second message indicating that target SeMF is the new provider of the sensing service.

In an aspect of the method, the method may further include receiving, by the target SeMF, from the at least one network function, an acknowledgement of the second message and transmitting, by the target SeMF, to the source SeMF, a response to the sensing context transfer request message.

In an aspect of the method, the method may further include transmitting, by the target SeMF, to an access and mobility management function (AMF), an acknowledgment of a handover notification message that was transmitted by the AMF to the source SeMF.

In accordance with aspects of the disclosure, an apparatus includes at least one processor and at least one memory storing instructions which, when executed by the at least one processor, causes the apparatus at least to perform a method as in any one of the preceding paragraphs.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment apparatus (UE), according to one illustrated aspect of the disclosure;

FIG. 2 is a diagram of example components of a network system, according to one illustrated aspect of the disclosure;

FIG. 3 diagram illustrating an example use case where the user equipment apparatus is assistance in UAV flight trajectory, according to one illustrated aspect of the disclosure;

FIG. 4 is a diagram illustrating another example use case where the user equipment apparatus is providing transparent sensing, spatial mapping, and localization, according to one illustrated aspect of the disclosure;

FIG. 5 is a diagram illustrating another example use case where the user equipment apparatus is detecting an intruder in a smart home, according to one illustrated aspect of the disclosure;

FIG. 6A and FIG. 6B are diagrams of an example embodiment of components of a user equipment apparatus or of a network apparatus, according to one illustrated aspect of the present disclosure;

FIG. 7A and FIG. 7B are diagrams of an example embodiment of components of a user equipment apparatus or of a network apparatus, according to one illustrated aspect of the present disclosure;

FIG. 8A, FIG. 8B, and FIG. 8C are diagrams of an example embodiment of components of a user equipment apparatus or of a network apparatus, according to one illustrated aspect of the present disclosure;

FIG. 9A and FIG. 9B are diagrams of an example embodiment of components of a user equipment apparatus or of a network apparatus, according to one illustrated aspect of the present disclosure;

FIG. 10A and FIG. 10B are diagrams of an example embodiment of components of a user equipment apparatus or of a network apparatus, according to one illustrated aspect of the present disclosure;

FIG. 11A, FIG. 11B, and FIG. 11C are diagrams of example embodiment of components of a user equipment apparatus or of a network apparatus, according to one illustrated aspect of the present disclosure;

FIG. 12A, FIG. 12B, and FIG. 12C are diagrams of example embodiment of components of a user equipment apparatus or of a network apparatus, according to one illustrated aspect of the present disclosure;

FIG. 13A, FIG. 13B, and FIG. 13C are diagrams of example embodiment of components of a user equipment apparatus or of a network apparatus, according to one illustrated aspect of the present disclosure;

FIG. 14A and FIG. 14B are diagrams of an example embodiment of components of a user equipment apparatus or of a network apparatus, according to one illustrated aspect of the present disclosure;

FIG. 15 is a diagram of an example embodiment of components of a user equipment apparatus or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX™), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE™), LTE-Advanced, enhanced LTE (eLTE), 5G New Radio (5G NR), 5G Advance, 6G (and beyond) and 802.11ax (Wi-Fi™ 6), among other wireless networking systems. The term ‘eLTE’ here denotes the LTE evolution that connects to a 5G core. LTE™ is also known as evolved UMTS terrestrial radio access (EUTRA) or as evolved UMTS terrestrial radio access network (EUTRAN).

Aspects of the present disclosure relate to a network service that uses the widespread geographic coverage of wireless networking infrastructure and user equipment (UE) to provide sensing services. The network service will be referred to herein as “sensing management function” or “SeMF” and, as described herein, may be implemented in a core network of a wireless network. As explained in more detail below herein, the network service is based on collaboration between wireless network infrastructure and UEs. In aspects, UEs with sensing capabilities may be called upon by the SeMF to perform sensing and to report sensed data to the SeMF. In aspects, the SeMF may call upon UEs to transmit signals for network nodes (e.g., gNB) to sense, and the network nodes may report sensed data to the SeMF. In aspects, the SeMF may call upon UEs to sense signals transmitted by network nodes and to report sensed data to the SeMF. The terms sensing management function and SeMF are merely examples of names for the network function. It is contemplated that the network function may be called any other name or may be implemented into any other network function.

UE sensing capabilities may include one or more of the following: indication of parameters/features/types of sensing data that can be collected by the UE and, if available, information about the granularity of collected sensing data; indication of available sensing resources; local processing capability of sensing measurements/data; UE obfuscation capability on sensing measurements/data; indication of supported sensing services; indication on sensing using uplink (UL) and/or downlink (DL) pilot or reference signals for channel parameter estimation; indication on sensing using data or user plane signals for channel parameter estimation; indication of the (maximum) number of sensing resources (e.g., DL and/or UL sensing reference signals, data or user plane signals) supported by the respective UE ID, per sensing frequency layer; indication of (number of) sensing frequency layers on a certain frequency band; indication of supported frequency band for sensing (e.g., central frequency, bandwidth, 3GPP™ NR FR1 (n1, n3, n77, etc.), 3GPP™ NR FR2 (n257, n258, etc.)), supported frequency range for sensing (e.g., 600 MHz to 6 GHZ, 24 GHz to 71 GHz), supported Radio Access Technology for sensing, max Tx power, supported bandwidth, sensing signal interval, etc.

In aspects, one or more network subscriptions may be implemented specifically with regard to enrolling a UE in the sensing services. The SeMF may operate as a sensing service provider to application functions in the core network and/or to applications in a UE or elsewhere, which would operate as sensing service consumers. These and other aspects are described in detail below.

The present disclosure may use the term “serving network device” to refer to a network node or network device (or a portion thereof) that serves a UE. As used herein, the terms “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

As used herein, the term “apparatus” refers to and includes a physical implementation that may include one housing and/or component or may include more than one housing and/or component. In case of more than one housing and/or component, the multiple housings and/or components of an apparatus may be co-located or may be geographically separated.

The present disclosure uses 5G NR as an example of a wireless network and may use smartphones and/or IoT devices as an example of UEs. It is intended and shall be understood that such examples are merely illustrative, and the present disclosure is applicable to other wireless networks and user equipment.

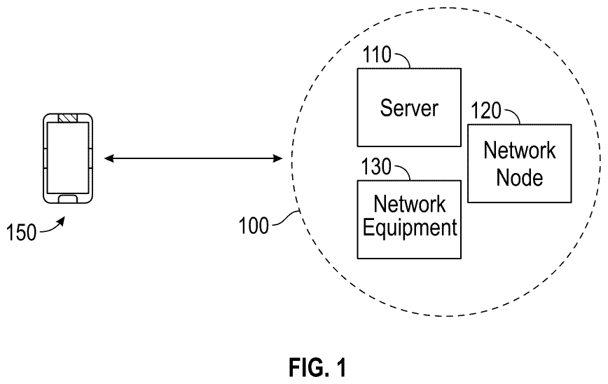

FIG. 1 is a diagram depicting an example of wireless networking between a network system 100 and a user equipment (UE) 150. The network system 100 may include one or more network nodes 120, one or more servers 110, and/or one or more network equipment 130 (e.g., physical infrastructure). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, aspects of a radio access network (RAN), or aspects of a core network, among others. The present disclosure describes embodiments related to 5G NR and embodiments that involve aspects defined by 3rd Generation Partnership Project (3GPP™). However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides NR user plane and control plane protocol terminations towards the UE and that is connected via a NG interface to the 5G core (5GC), e.g., according to 3GPP™ TS 38.300 V16.6.0 (2021 June) section 3.2, which is hereby incorporated by reference herein.

A gNB supports various protocol layers, e.g., Layer 1 (L1)-physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QOS) flows;
Control channels include broadcast control channel (BCCH) and physical control channel (PCCH).

Layer 3 (L3) includes, e.g., radio resource control (RRC), e.g., according to 3GPP™ TS 38.300 V16.6.0 (2021 June) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

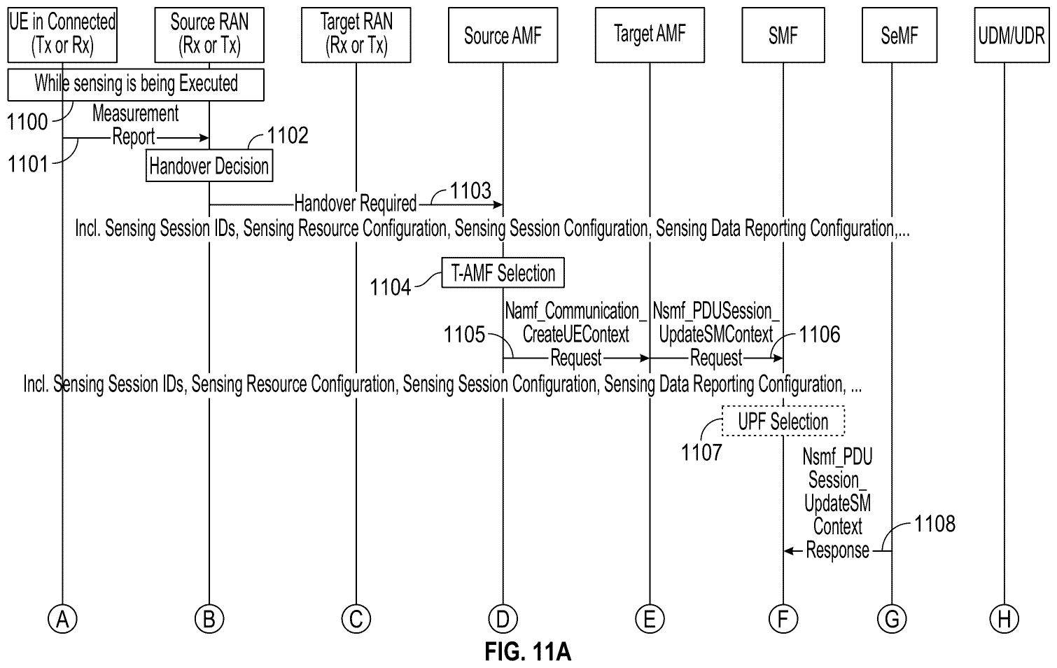

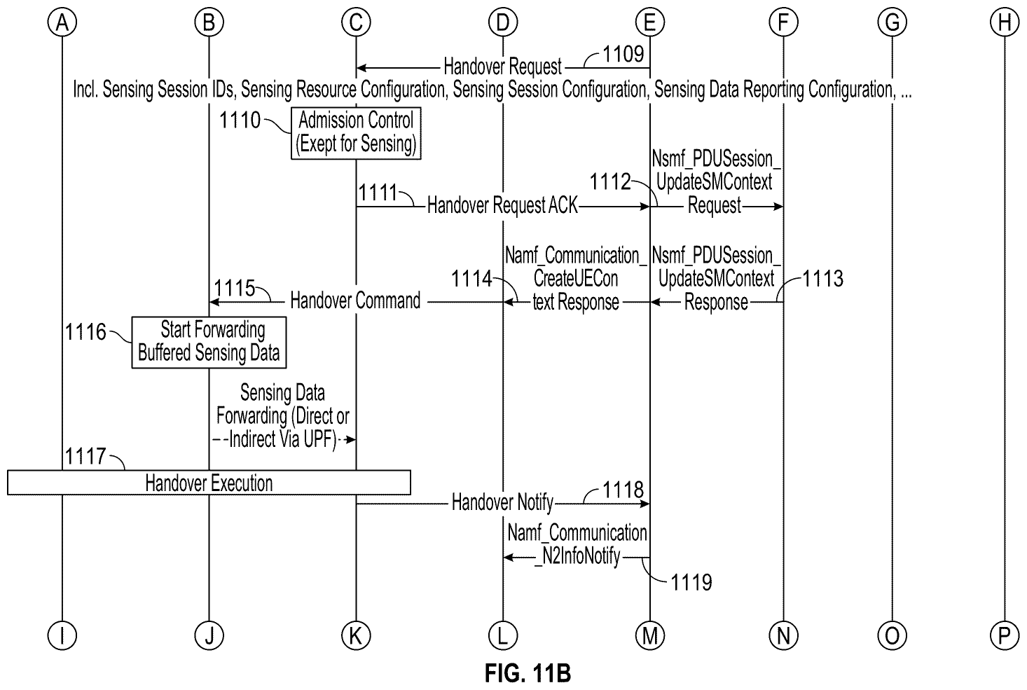

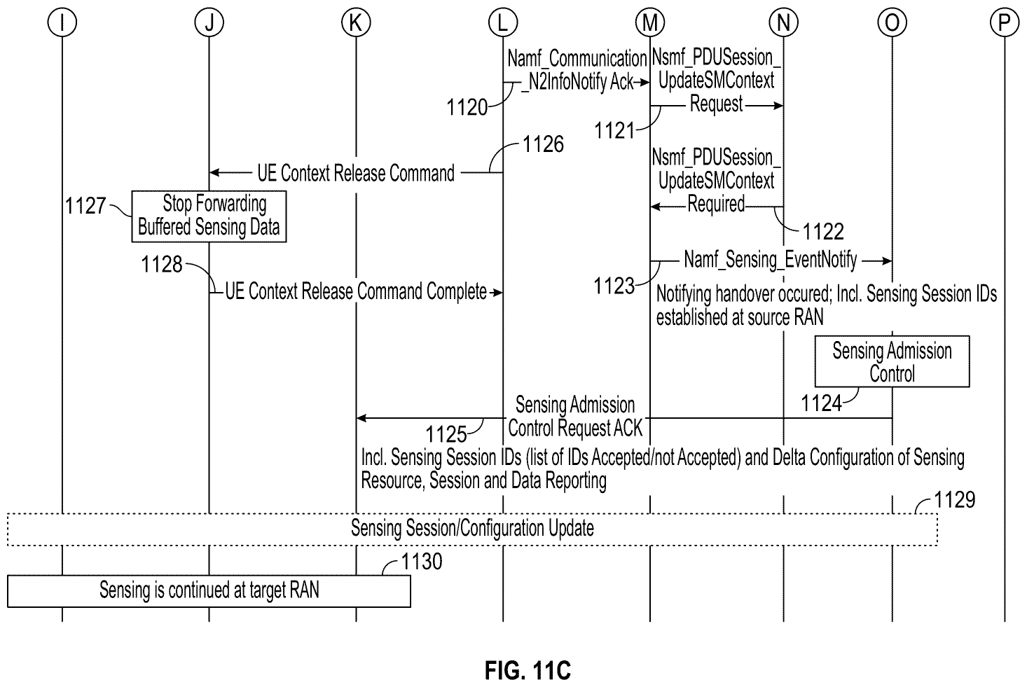

As used herein, the term “network node” may refer to any of a gNB, a gNB-CU, or a gNB-DU, or any combination of them. A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-) layer of a RAN (radio access network), e.g., layer 2 and/or layer 3. Different functional splits between the central and distributed unit are possible. An example of such an apparatus and components will be described in connection with FIG. 11 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment (UE) or support a candidate cell for handover, dual connectivity, and/or carrier aggregation, among other procedures.

The user equipment (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 11. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment may be in communication with the network system 100.

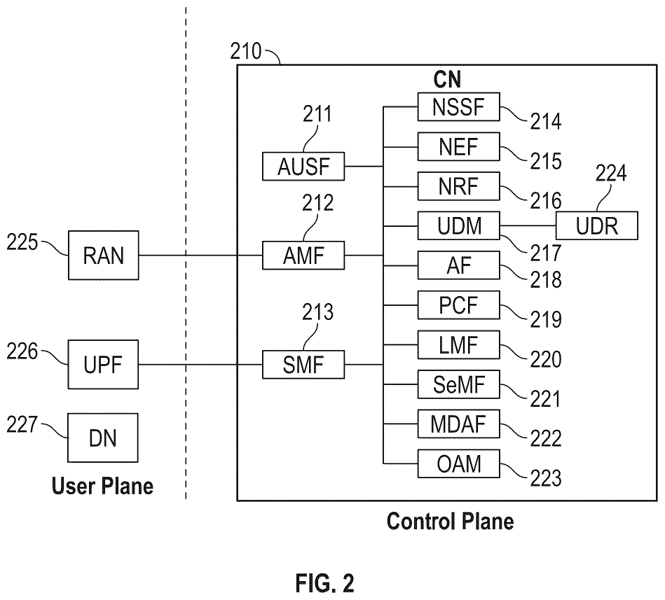

FIG. 2 is a block diagram of example components of the network system 100 of FIG. 1. A 5G NR network may be described as an example of the network system 100, and it is intended that aspects of the following description shall be applicable to other types of network systems, as well. The network system may operate in accordance with the signals and connections shown in FIG. 1 such that the UE 150 is in communication with the network system 100 through the radio access network 225. Additionally, the network system may be divided into user plane components and functions and control plane components and functions, as shown and described herein. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be virtual connections over service-based interfaces such that any component may communicate with any other component. In this manner, any component may act as a service “producer,” for any other component that is a service “consumer,” to provide services for network functions.

For example, a core network 210 is described in the control plane of the network system. The core network 210 includes an authentication server function (AUSF) 211, an access and mobility function (AMF) 212, and a session management function (SMF) 213. The core network 210 also includes a network slice selection function (NSSF) 214, a network exposure function (NEF) 215, a network repository function (NRF) 216, and a unified data management function (UDM) 217, which may include a uniform data repository (UDR) 224.

Additional components and functions of the core network 210 include an application function (AF) 218, policy control function (PCF) 219, location management function (LMF) 220, sensing management function (SeMF) 221, management data analytics function (MDAF) 222, and operations and management function (OAM) 223.

The user plane includes the UE 150, a radio access network (RAN) 225, a user plane function (UPF) 226, and a data network (DN) 227. The RAN 225 may include one or more components described in connection with FIG. 1, such as one or more network nodes. However, the RAN 225 may not be limited to such components. The UPF 226 provides connection for data being transmitted over the RAN 225. The DN 226 identifies services from service providers, Internet access, and third party services, for example.

The AMF 212 processes connection and mobility tasks. The AUSF 211 receives authentication requests from the AMF 212 and interacts with UDM 217 to authenticate and validate network responses for determination of successful authentication. The SMF 213 conducts packet data unit (PDU) session management, as well as manages session context with the UPF 226.

The NSSF 214 may select a network slicing instance (NSI) and determine the allowed network slice selection assistance information (NSSAI). This selection and determination is utilized to set the AMF 212 to provide service to the UE 150. The NEF 215 secures access to network services for third parties to create specialized network services. The NRF 216 acts as a repository to store network functions to allow the functions to register with and discover each other.

The UDM 217 generates authentication vectors for use by the AUSF 211 and ADM 212 and provides user identification handling. The UDM 217 may be connected to the UDR 224 which stores data associated with authentication, applications, or the like. The AF 218 provides application services to a user (e.g., streaming services, etc.). The PCF 219 provides policy control functionality. For example, the PCF 219 may assist in network slicing and mobility management, as well as provide quality of service (QOS) and charging functionality.

The LMF 220 operates to receive location measurements and location assistance information from the RAN and the UE, via the AMF. The SeMF 221 manages collection of sensing data and will be described in more detail below herein. The MDAF 222 provides additional data analytics services for network functions. The OAM 223 provides provisioning and management processing functions to manage elements in or connected to the network (e.g., UE 150, network nodes, etc.).

FIG. 2 is merely an example of components of a network system, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

As described above, the sensing management function (SeMF) manages collaboration between wireless network infrastructure and UEs to realize sensing services. In aspects, UEs with sensing capabilities (e.g., IoT devices, smartphones, etc.) may be called upon by the SeMF to perform sensing, and/or to transmit signals for network nodes (e.g., gNB, picocells, femtocells, etc.) to sense, and/or to sense signals transmitted by network nodes (e.g., gNB, picocells, femtocells, etc.). The SeMF may operate as a sensing service provider to application functions in the core network and/or to applications in a UE or other device, which would operate as sensing service consumers.

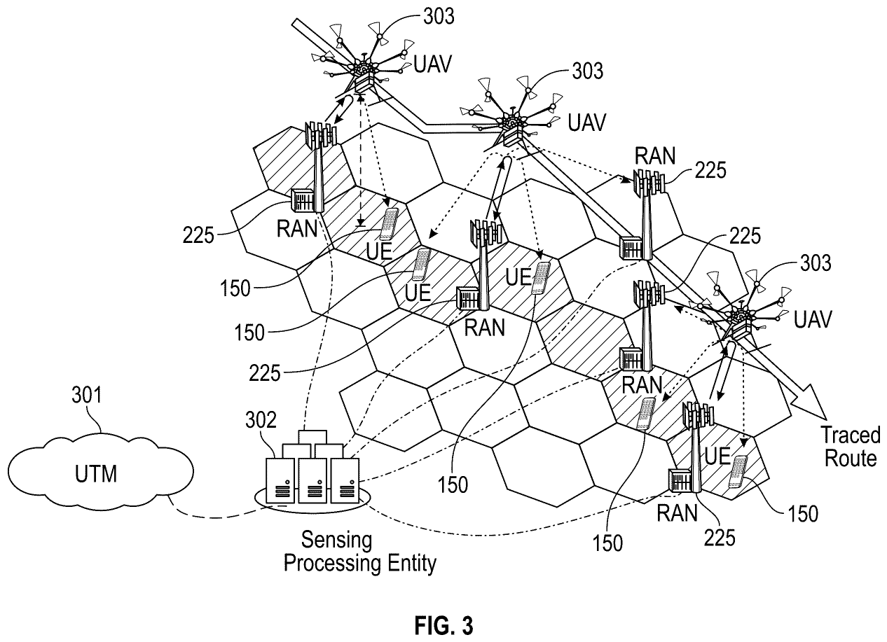

As an example scenario, a 5G network subscriber (e.g., a company) may wish to deploy network nodes (e.g., picocells, femtocells, etc.) and UEs (e.g., IoT devices, etc.) for the subscriber's business sensing needs. In embodiments, the network nodes and UEs may be owned by the subscriber or may be leased from the network operator, and they may have a subscription with the network to use sensing services over the network. The SeMF may provide the sensed data to an application that uses the sensed data for various purposes. With sufficient amounts of sensed data, an application may, for example, use sensed data to obtain awareness of a scene surrounding a user equipment, to detect, localize, and track objects, and/or to form images and/or to extract features for recognition/classification purposes, among other purposes. As used herein, the term “3GPP™ sensing data” refers to and includes data derived from 3GPP™ radio signals that are impacted (e.g., reflected, refracted, diffracted) by an object or environment of interest for sensing purposes, and that can optionally be processed within the 5G system. 3GPP™ sensing data is just one type of sensed data contemplated by the present disclosure. Various example uses of sensed data are described in connection with FIGS. 3-5 below.

FIG. 3 is a diagram illustrating an example use case of using sensing services in UAV flight trajectory tracing. FIG. 3 illustrates a radio access network (RAN) 225, which may include network nodes such as gNB, and UEs 150 connected to the RAN 225. In the example of FIG. 3, the network nodes and the UEs 150 may be called upon by the SeMF to provide sensed data, which may then be used by an application, to trace the flight of an unmanned aerial vehicle (UAV) 303. The application may be an application of an unmanned aircraft system traffic management (UTM) system 301. The sensed data provided by the network nodes and/or the UEs 150 may be provided by the SeMF to a sensing processing entity 302, such as a 5G sensing processing entity, which may transmit the sensed data to the UTM system 301. The sensing processing entity 302 may also receive requests for sensed data from the UTM system 301.

For example, a UAV flight may be traced via sensing performed by RAN 225 along the flight trajectory. Apart from acquiring sensed data by a RAN 225 (e.g., gNBs), UEs 150 connected to the RAN 225 can be configured to assist in obtaining sensing data. Potential scenarios in which the UE 150 may aid in obtaining sensed data include, for example, where a UE 150 is a shorter distance away from the UAV than the RAN nodes, and/or where the UE is in the reflection direction with larger radar cross section (RCS) than the RAN nodes. The SeMF may be able to, for example, authorize RAN entities and UEs in certain location areas to generate and report sensed data (e.g., relating to a UAV position, velocity, etc.) to a 5G sensing processing entity 302.

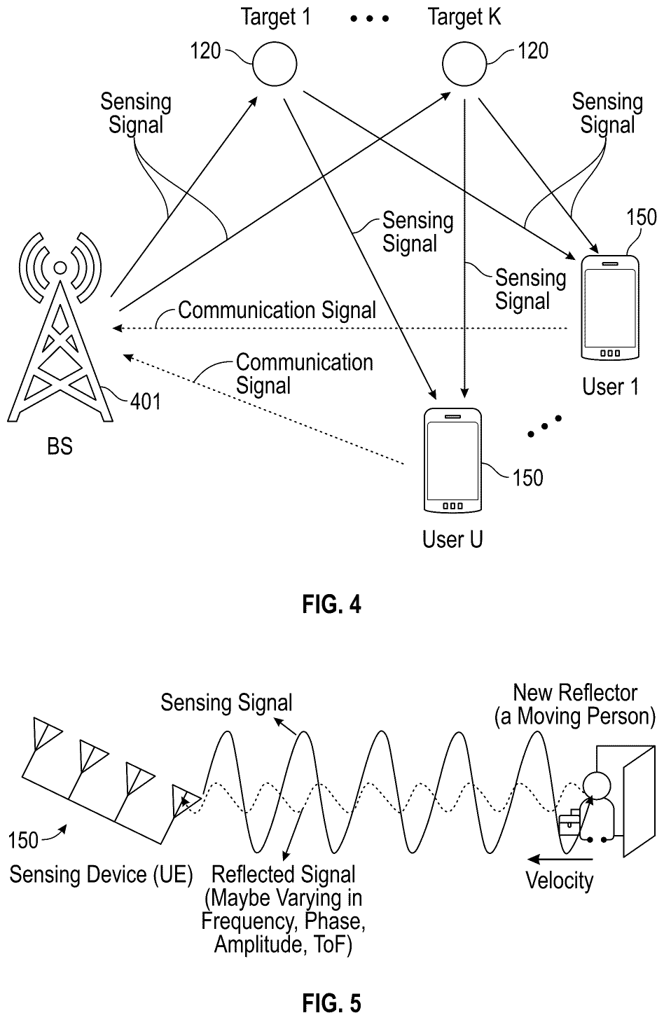

Another use case can include, for example, transparent sensing and spatial mapping/localization, in which sensed data is used to create a spatial (3D) map usable for localizing objects (not shown). UEs in the target area to be 3D-mapped can be involved in producing sensed data in the manner illustrated in FIG. 4. In FIG. 4, the SeMF may support a mechanism to enable RAN nodes 401 and UEs 150 to cooperate to acquire NR-based sensed data to capture information about the nearby environment, such as information about target objects 120 in the environment. In the illustrated embodiment, a RAN node 401 transmits sensing signals (e.g., reference signals), some of which may interact with (e.g., reflect off) the one or more targets 120. The sensing signals resulting from the interactions may be sensed by the UEs 150 as sensed data. The sensed data may be transmitted by the UEs 150 to the network nodes 401 in communication signals, to be used by a service consumer of the SeMF to produce or modify a spatial map.

FIG. 5 illustrates another example use case for detecting an intruder in a home. RAN nodes (e.g., picocell or femtocell, etc.) or UE 150 deployed at or near a home may be used as a sensing signal transmitter, sensing signal receiver, or both. In this scenario, specific RAN node(s) and/or UE(s) 150 in or nearby the home may be selected to perform the transmission or sensing. As shown in FIG. 5, a sensing signal is transmitted and, when it is reflected off a reflector, such as a moving person, the reflected signal may have a frequency, phase, amplitude, or time of flight (ToF) that is different from those of a reference reflected signal or a baseline reflected signal. The different reflected signal characteristics may be sensed as sensed data, which may be used to detect whether an intruder has entered the home.

For the above example use cases of FIGS. 3-5, at least one of the following two sensing methods may be used, with UE(s) cooperation, for the realization of the sensing service: RAN (e.g., a network node) transmits a sensing signal and the UE(s) receives the sensing signal to obtain sensed data; and/or the UE transmits a sensing signal and RAN (e.g., a network node) receives it to obtain sensed data. In this manner, a 5G network subscriber (e.g., a company) who wishes to deploy network nodes (e.g., picocells, femtocells, etc.) and UEs (e.g., IoT devices, etc.) for the subscriber's business sensing needs may provide sensing capabilities over a much larger area (e.g., the coverage area of a 5G network).

In embodiments, various other sensing methods can be used to improve the accuracy of sensing results, such as, without limitation: sensing in a specific geographical region specified using GPS coordinates or in a geographically scoped description (e.g., circular area, rectangular area, ellipsoidal area, or other suitable shape); sensing to a defined side/area of the UE (e.g., the UE serving as a reference point or reference device), e.g., sensing at specific angle of the UE, side of the UE, or 360 degrees around the UE; and/or sensing in a range beyond one or more UEs (e.g., the UE serving as a reference point or reference device). In embodiments, the reference UE/device that is used to define the sensing area can be also the UE that assists in the sensing procedure (i.e., having the role of transmitter of sensing signals or receiver of sensing signals). The sensing method(s) that are employed for a particular scenario may depend on the type of sensing service requested and/or other factors. The examples of FIGS. 3-5 are merely illustrative, and other use cases are contemplated to be within the scope of the present disclosure.

Various examples of infrastructure and use cases were described above. From an implementation standpoint, a SeMF needs to determine which UEs have appropriate sensing capabilities for a sensing request and are also available for fulfilling the sensing request. Moreover, if a moving UE 150 (e.g., IoT device in a drone or vehicle) is selected to participate in the sensing services, the moving UE 150 may be subject to a handover and may switch to different cells and/or different networks. Such changes may affect sensing operations. The following addresses approaches to providing sensing service continuity when UEs relied upon in the sensing services may be moving UEs.

The following description refers to connection management (CM), which is a protocol used to establish and release the control plane signaling connection between a UE and an AMF. As persons skilled in the art will understand, a UE may have various connection management states, such as a CM-Connected state and a CM-Idle state, which are maintained at non-access stratum (NAS) layer at both UE and AMF. (NAS is a protocol that operates above the access stratum (AS), which deals with the radio interface, and that is responsible for establishing, maintaining, and releasing sessions between the user equipment and the core network.) CM-Idle defines a state in which the UE does not have signaling with the AMF. CM-Idle corresponds to RRC Idle in AS layer. In contrast, CM-Connected means that a UE has a signaling connection with the AMF. When a UE is powered on, it selects the best network node (e.g., gNB) based on cell selection procedure and transmits a registration request to initiate a radio resource control (RRC) connection setup signaling towards the network node (e.g., gNB) and to initiate N2 signaling to the AMF. The registration request triggers the transition from CM-Idle to CM-Connected. If a UE is in CM-Idle state and has to transmit uplink data, the UE triggers a service request NAS message to the AMF and changes from CM-Idle state to CM-Connected state. If there is downlink data to transfer toward a UE that is in CM-Idle state, the network initiates a state transition procedure using a paging message, which triggers the UE to establish RRC connection and to send a service request NAS message to the AMF. The service request triggers a N2 signaling connection, which moves the UE to CM-Connected state. A UE can move from CM-Connected state to CM-Idle state when its signaling connection is released or when its signaling connection fails. In aspects of the present disclosure, when a UE is providing sensed data for sensing services, the UE may be in the CM-Connected state.

In accordance with aspects of the present application, as mentioned above, the present disclosure relates to providing continuity of a sensing service due to mobility of UE(s) involved in a sensing service. The Xn-based and N2-based handover procedures from a Source RAN node (e.g., network node) to a Target RAN node are enhanced including provisioning of sensing configuration and other required information to support sensing admission control procedure that can take place at the Target RAN node or the SeMF. As persons skilled in the art will understand, “admission control” refers to a process of determining whether to grant and may include permissions to utilize network resources, such that sensing admission control procedure refers to and includes determining and granting of permissions to utilize network resources for sensing services and execute sensing to send a sensing signal as a transmitter or receive the sensing signal and correct the sensing data as a receiver.

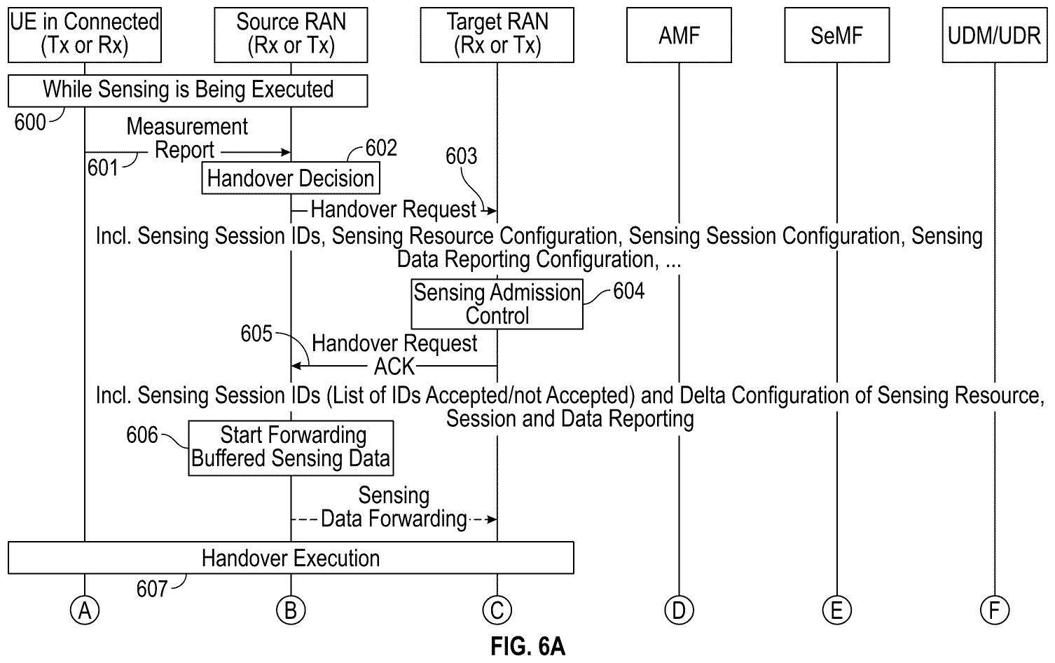

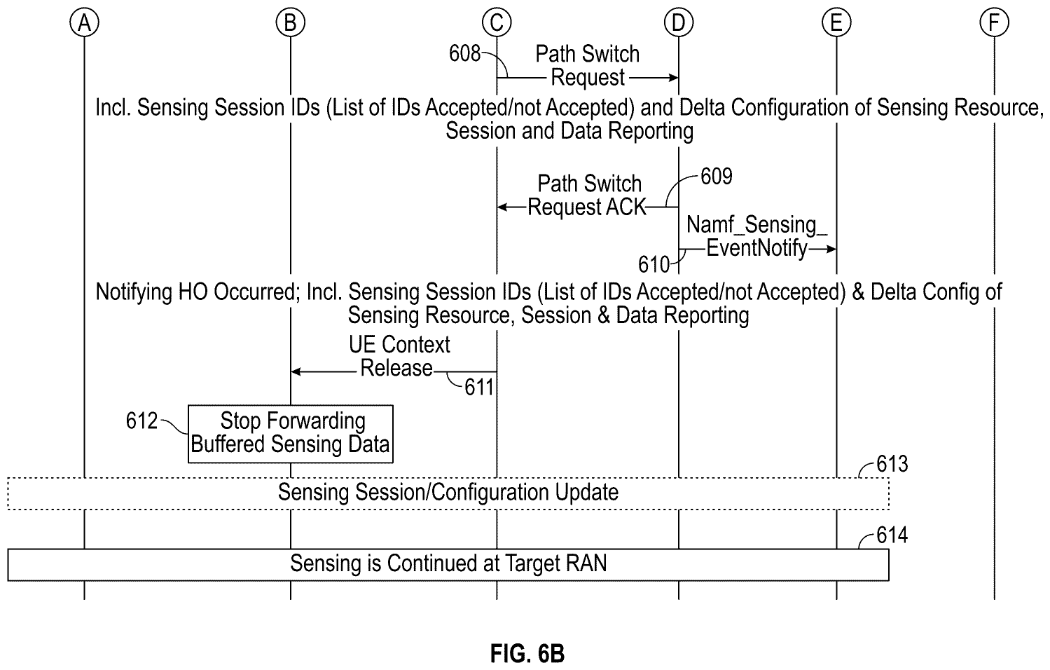

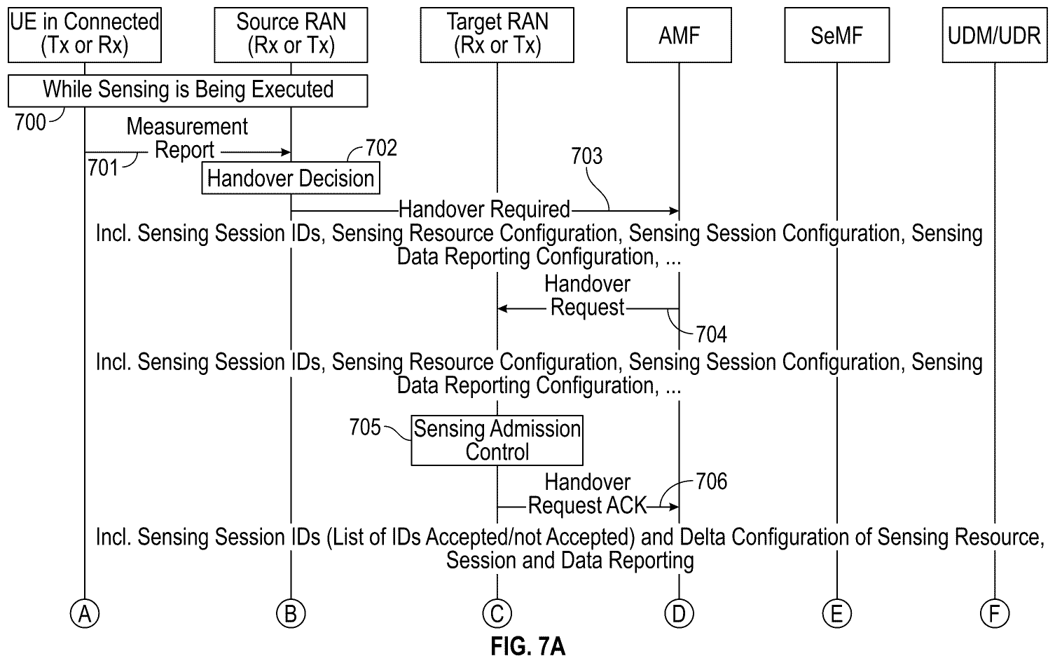

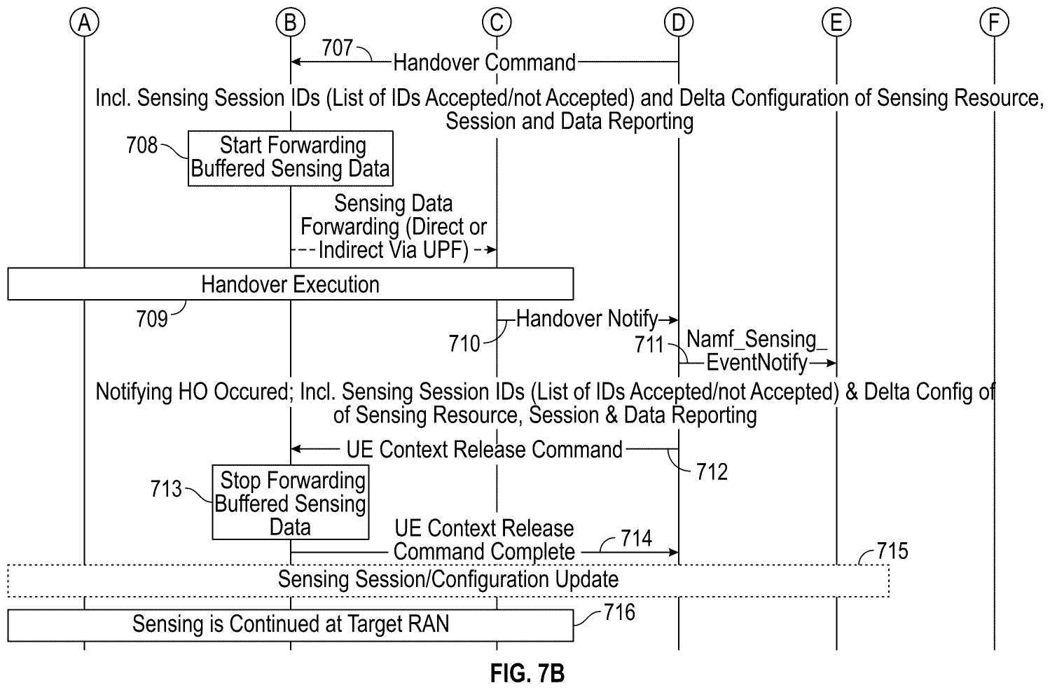

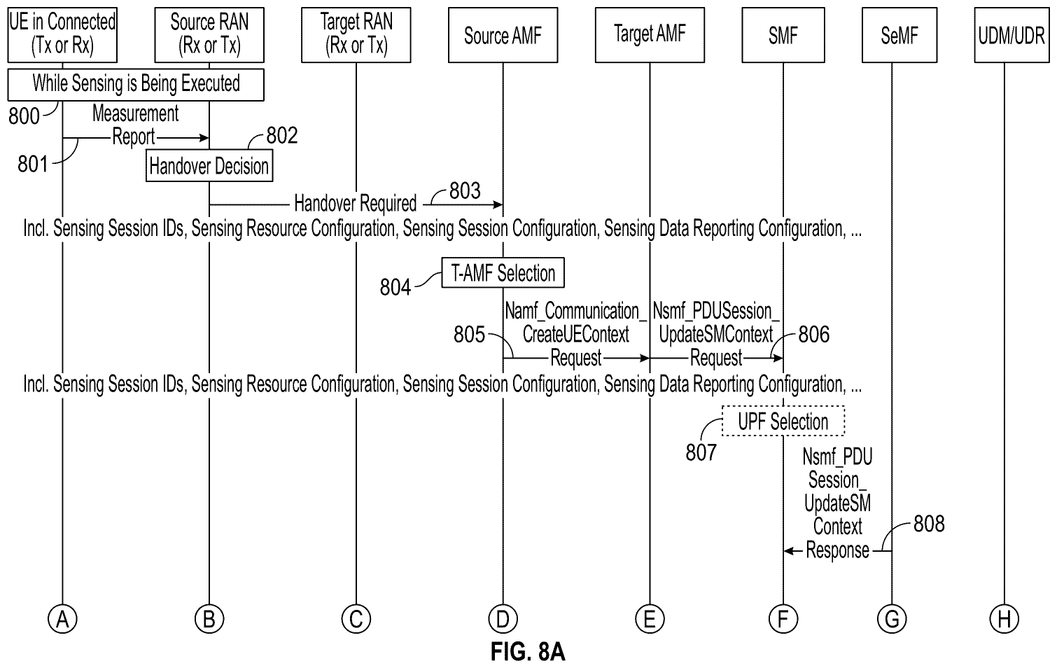

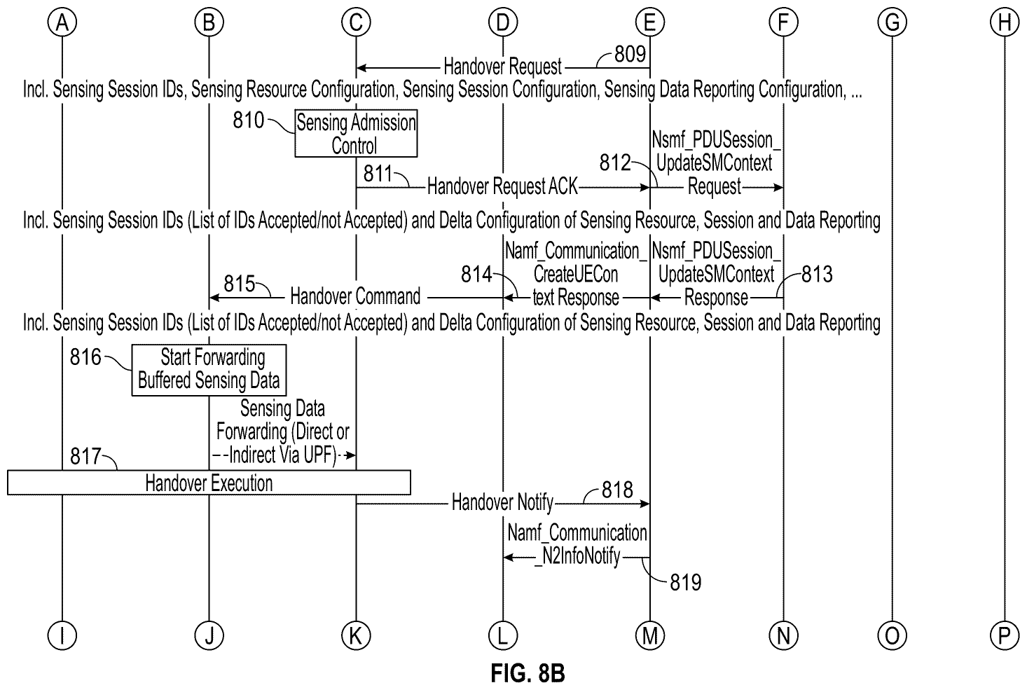

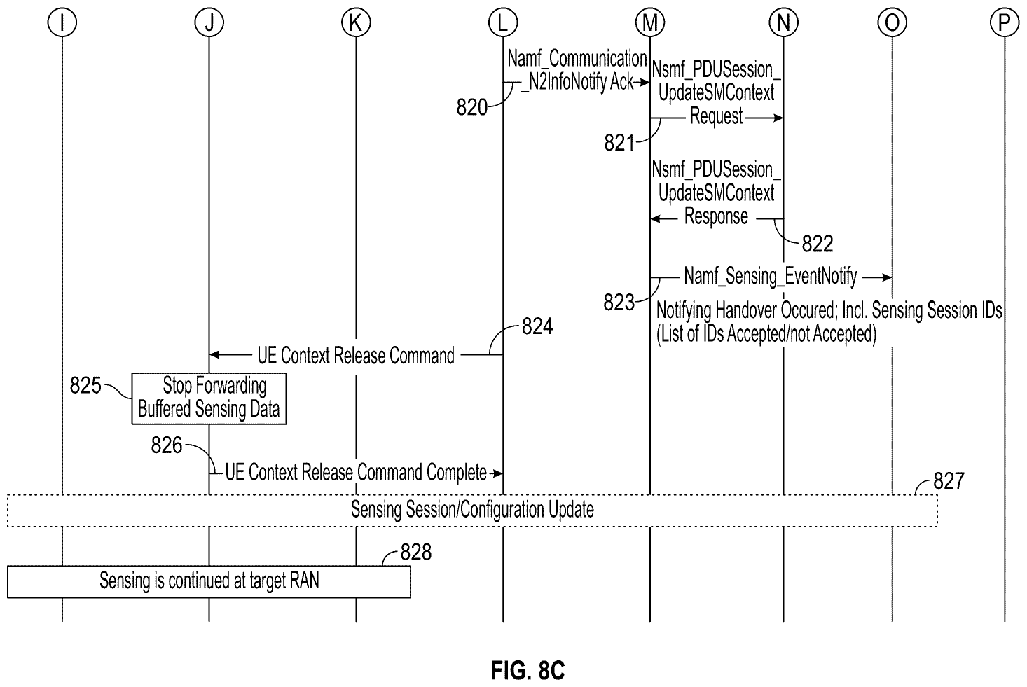

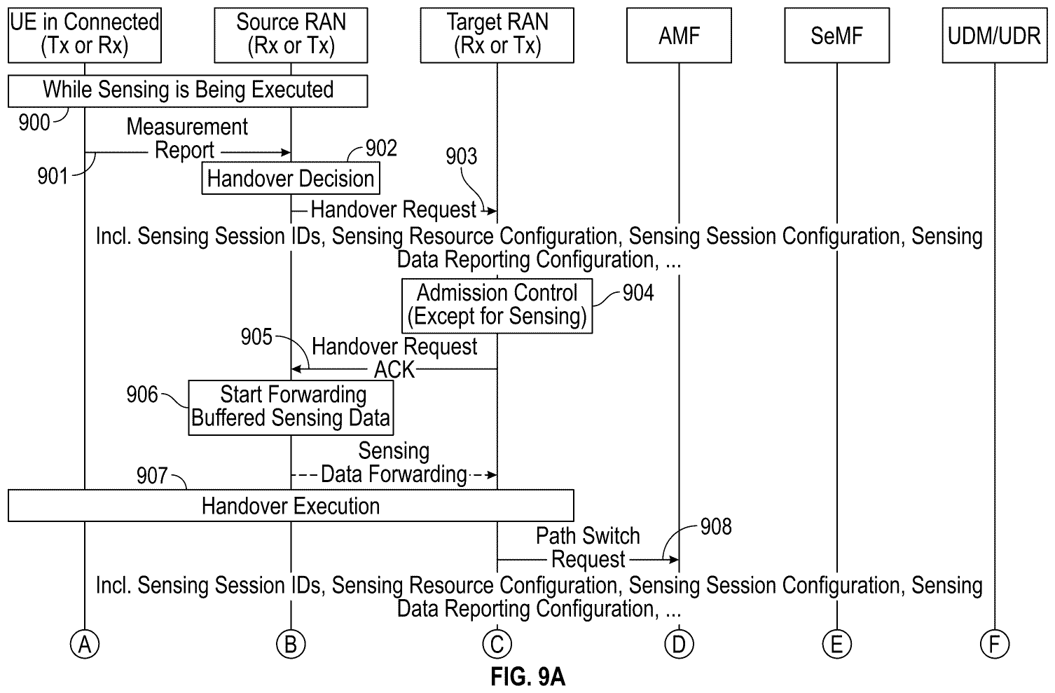

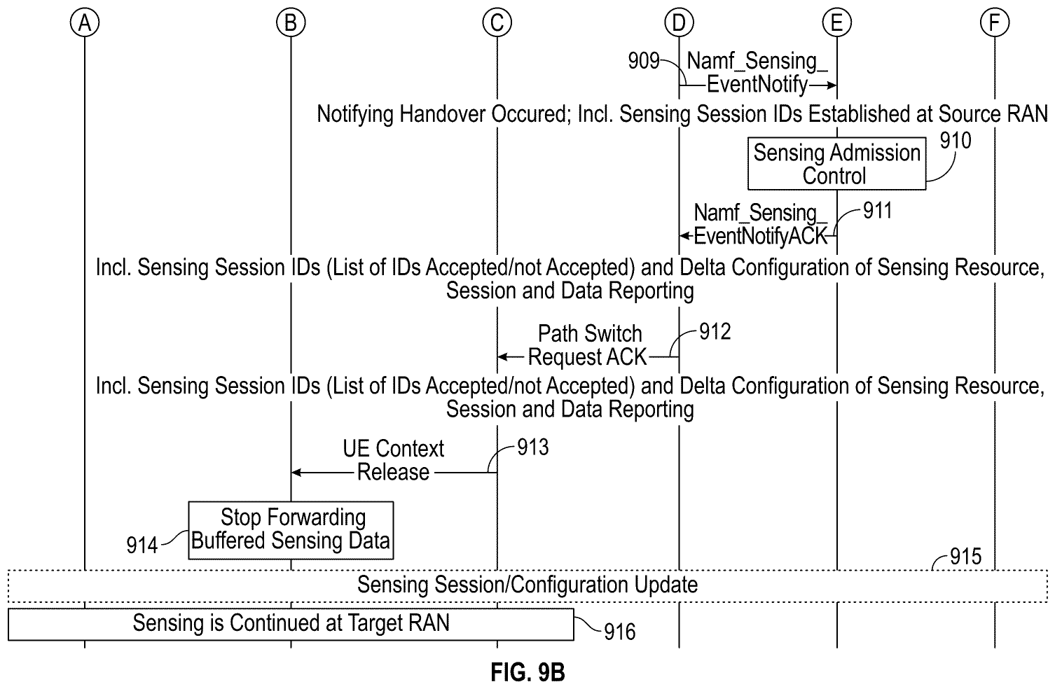

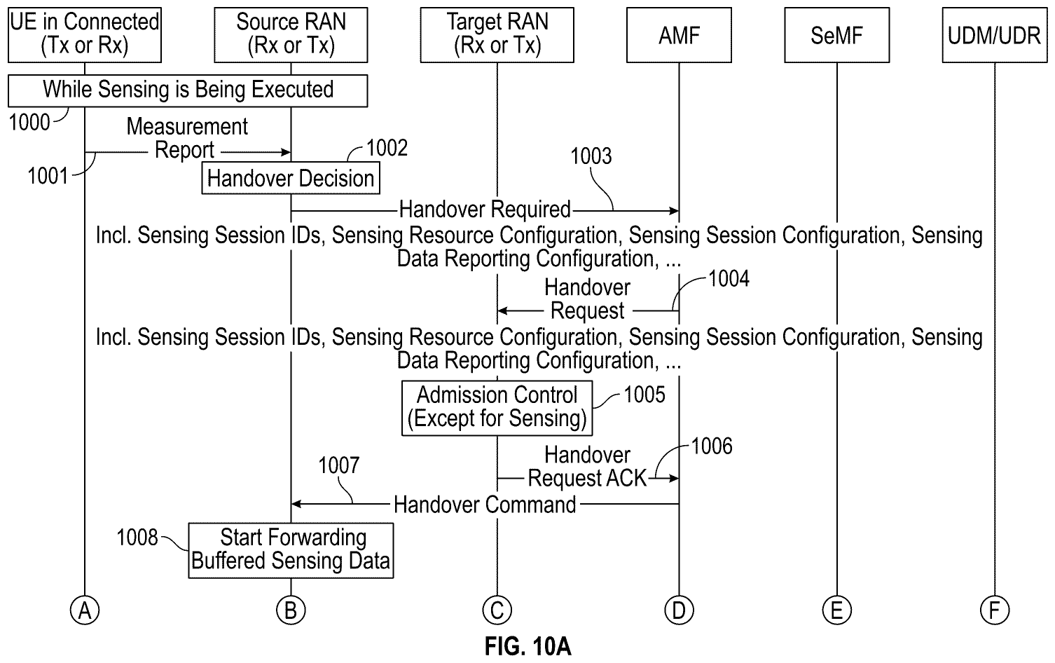

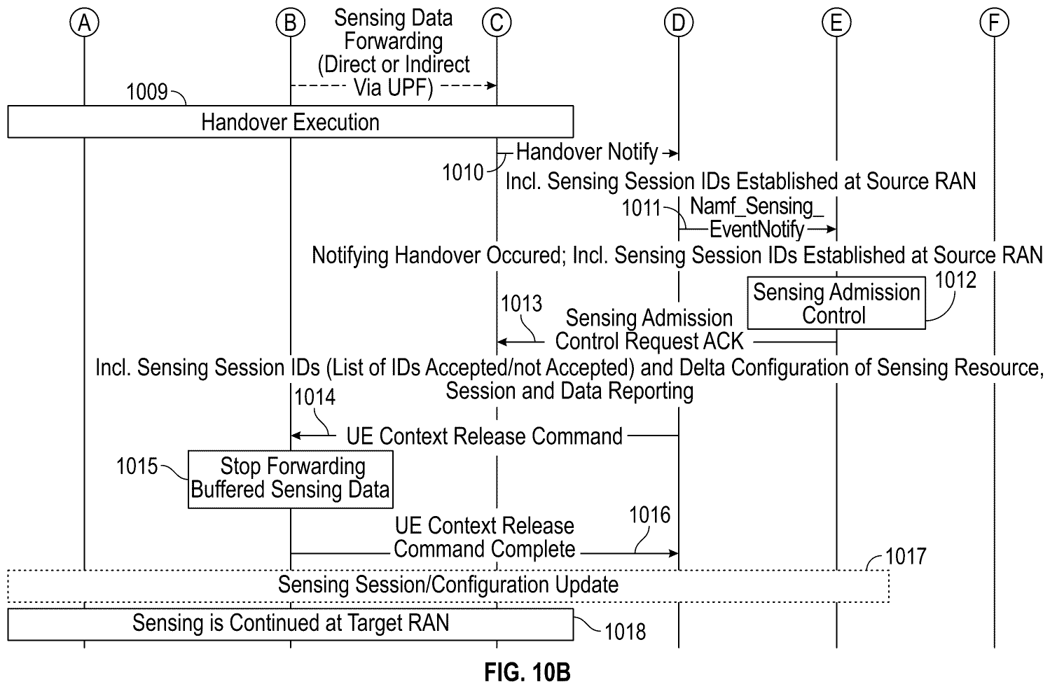

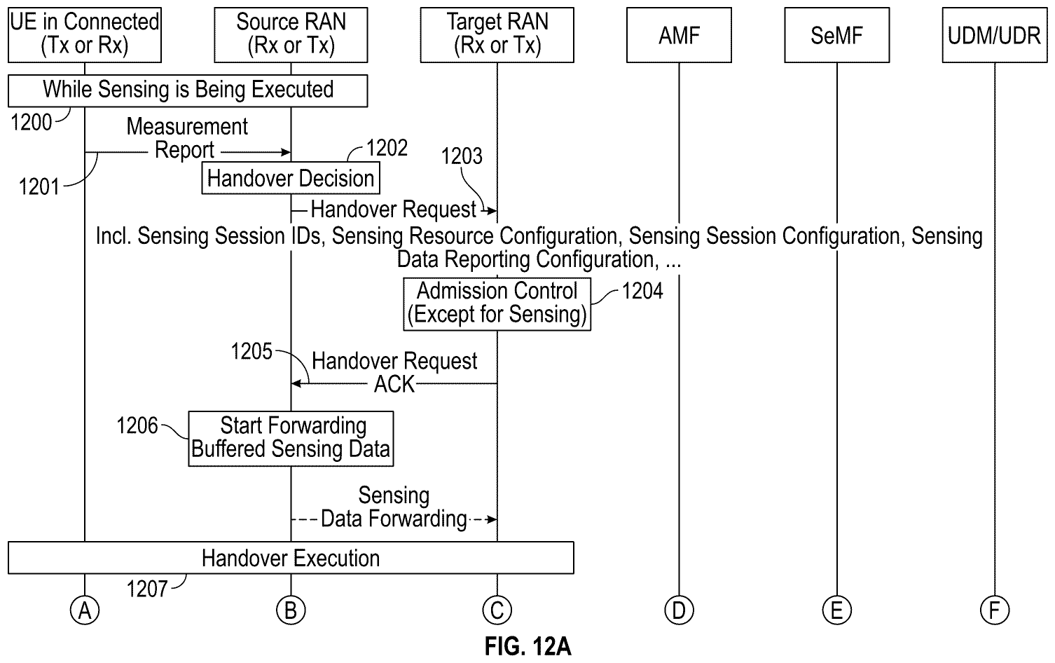

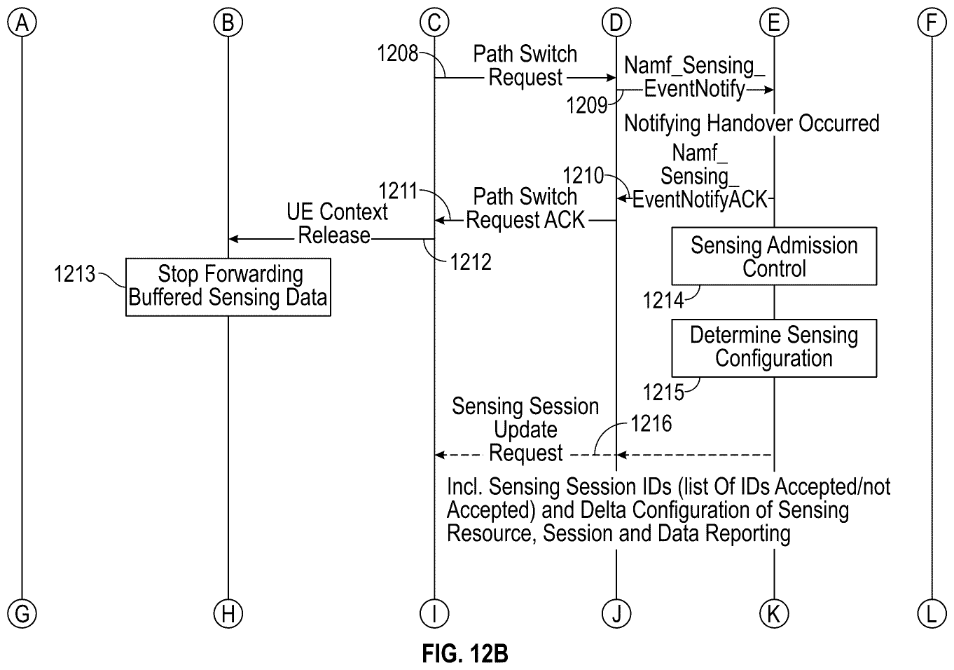

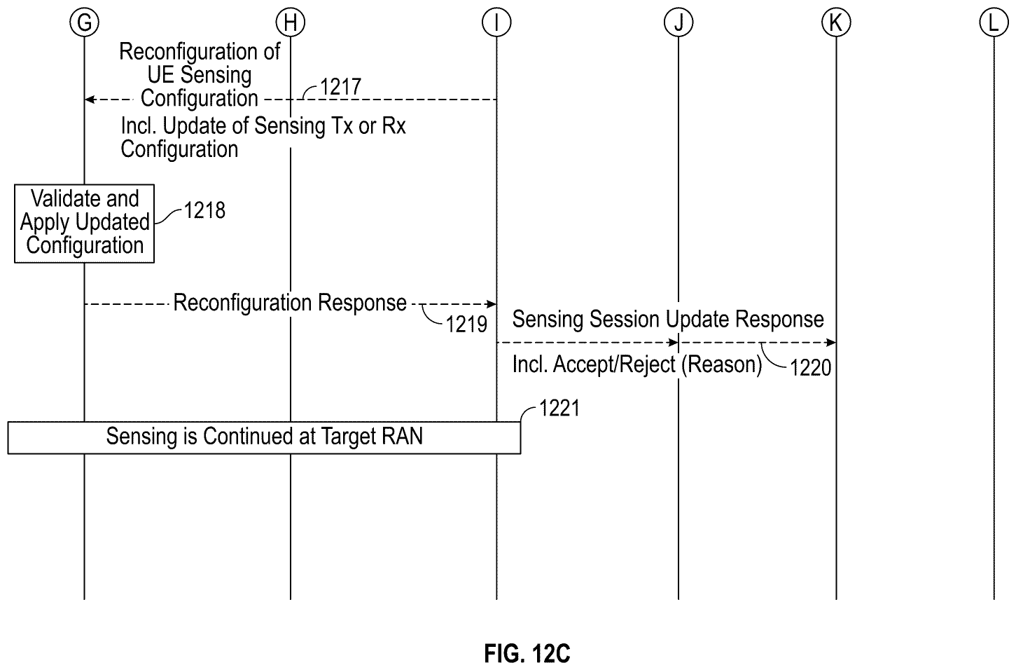

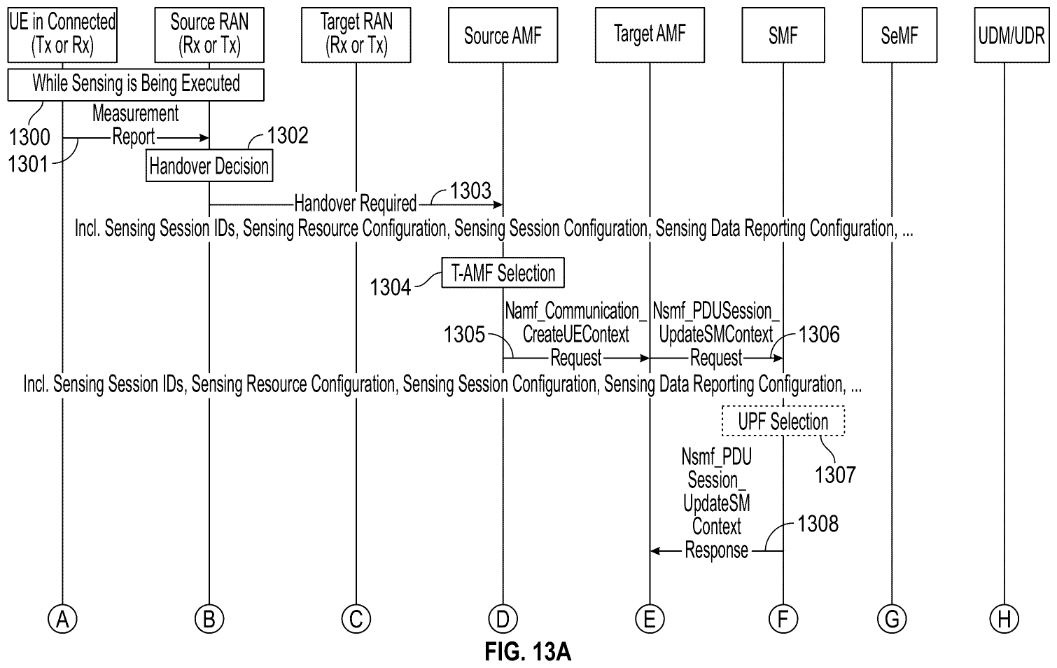

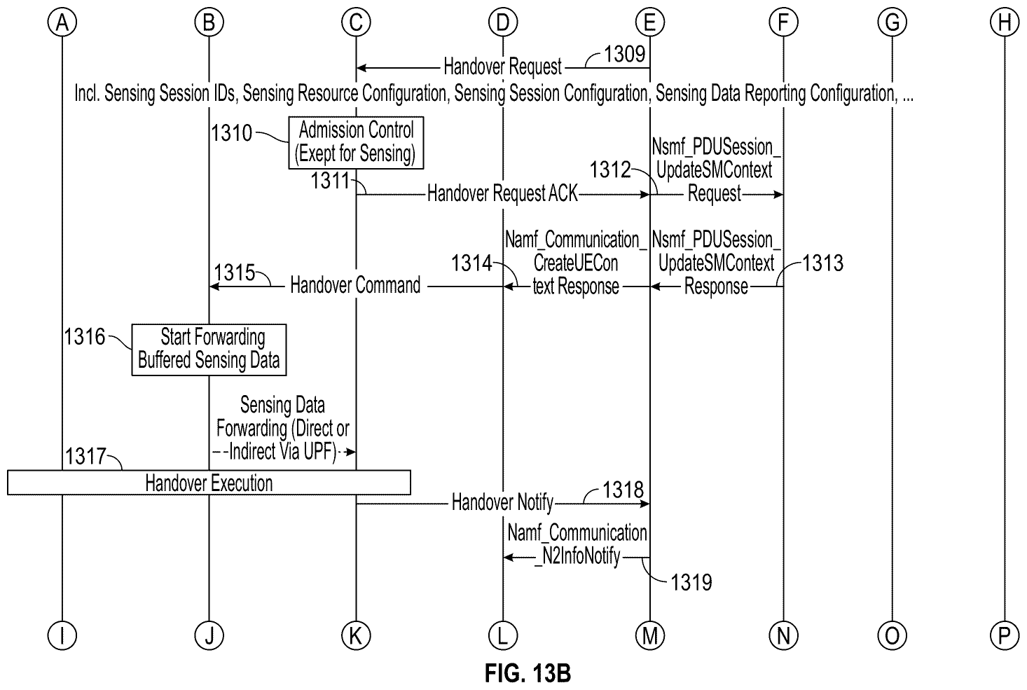

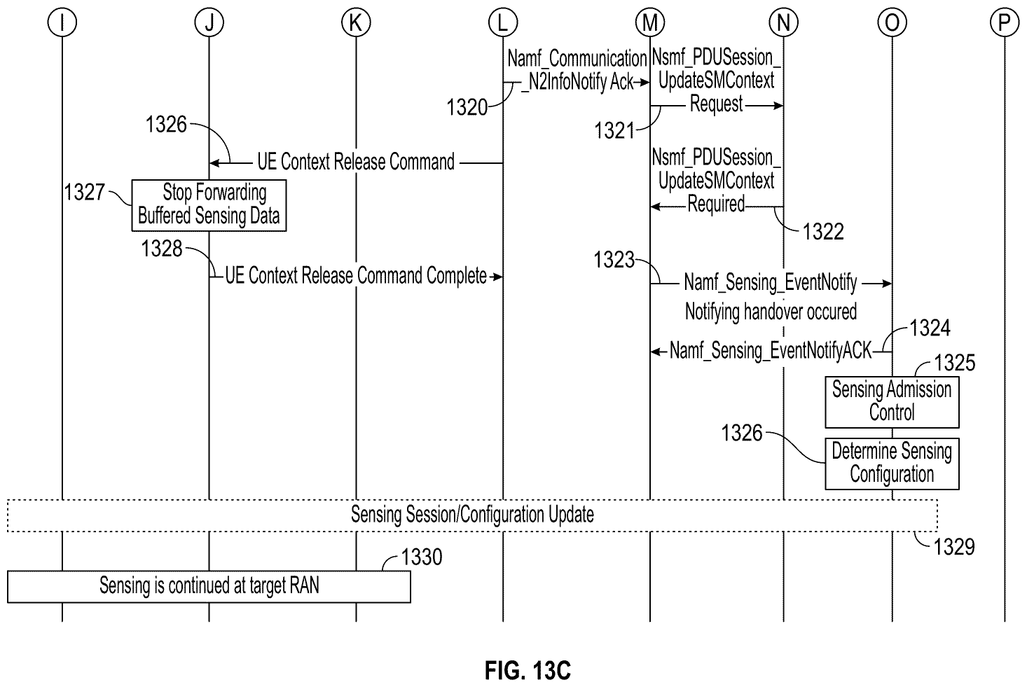

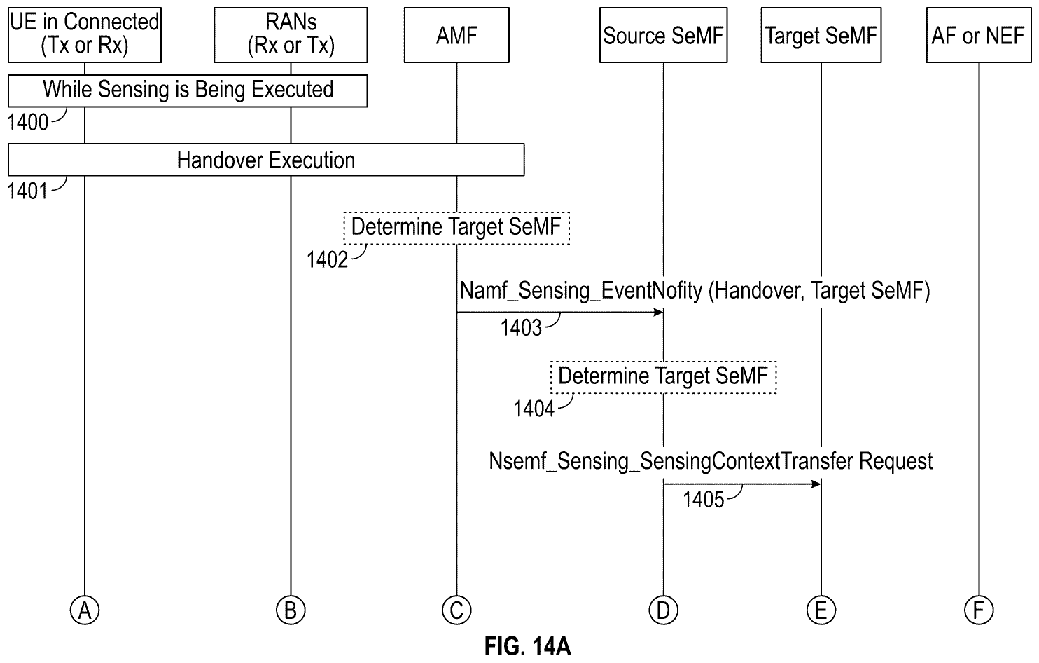

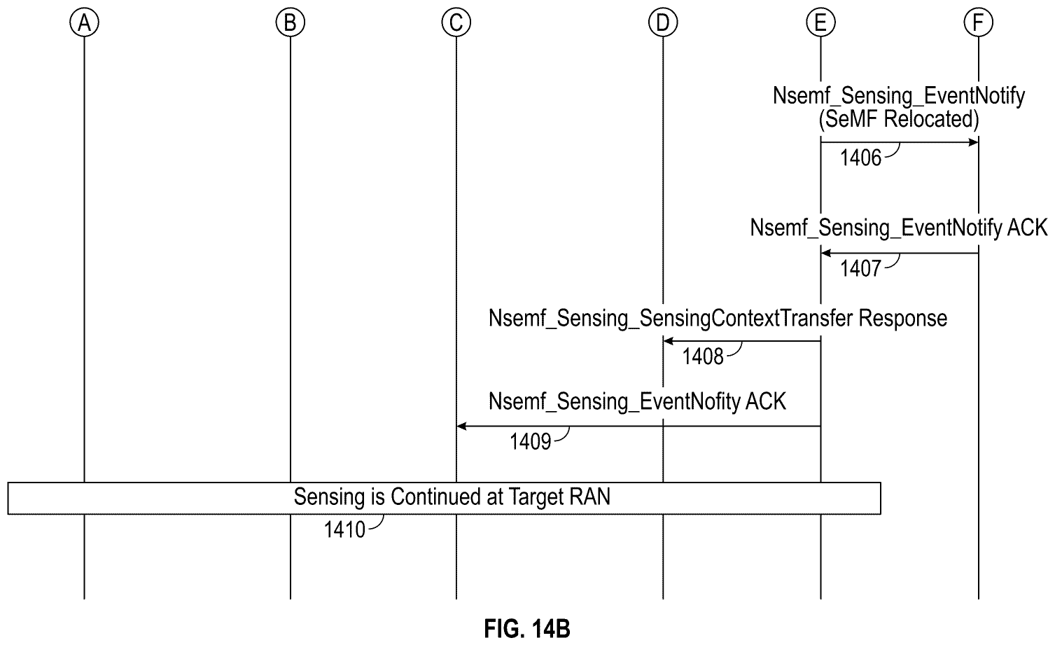

FIGS. 6A/6B, FIGS. 7A/7B, FIGS. 8A/8B, FIGS. 9A/9B, FIGS. 10A/10B, FIGS. 11A/11B/11C, FIGS. 12A/12B/12C, FIGS. 13A/13B/13C, and FIGS. 14A/14B, disclose procedures for sensing session continuity for various scenarios and configurations, such as in cases with Xn based handover or inter NG-RAN node N2 based handover, with session admission control performed at target RAN or at SeMF, and with or without AMF relocation or SeMF relocation. The scenarios and configurations are summarized as follows, and each is described in detail below herein. Each scenario and configuration apply to both bistatic sensing methods in which (1) the RAN transmits a sensing signal and the UE receives/senses, and (2) the UE transmits a sensing signal and the RAN receives/senses.

| | | Sensing admission | |
|---|---|---|---|
| FIGS. | Handover | control procedure by | Relocation |
| 6A/6B | Xn based | Target RAN | |
| 7A7/B | Inter NG-RAN | Target RAN | |
| | N2 based | | |
| 8A/8B | Inter NG-RAN | Target RAN | AMF relocation |
| | N2 based | | |
| 9A/9B | Xn based | SeMF | |
| 10A/10B | Inter NG-RAN | SeMF | |
| | N2 based | | |
| 11A/11B | Inter NG-RAN | SeMF | AMF relocation |
| | N2 based | | |
| 12A/12B/12C | Xn or N2 based | SeMF | SeMF relocation |
| 13A/13B/13C | Inter NG-RAN | SeMF | AMF relocation |
| | N2 based | | |
| 14A/14B | Inter NG-RAN | | SeMF relocation |
| | N2 based | | |

As the figures and the following description will show, in aspects, the following messages may include sensing session identifier(s), sensing resources configuration, sensing session configuration, and/or sensing data reporting configuration (which are described below): a handover required message, a handover request message, an AMF relocation request message (e.g., create UE context message, PDU session update session management (SM) context message), an AMF relocation request response message, and/or a path switch request.

In aspects, the following messages may include a list of accepted or not accepted sensing session IDs and include new or updated sensing resource configuration, sensing session configuration, and/or sensing data reporting configuration, e.g., as delta configurations: a handover request acknowledgment message, a handover command message, a message notifying that handover occurred, a response message or acknowledge message to a notification that handover occurred, a path switch request message, a path switch acknowledgment message, a sensing admission control procedure request acknowledgment message, and/or a sensing session update request message.

In aspects, a source RAN may buffer sensing data and/or forward sensing data to a target RAN prior to handover execution

FIG. 6A and FIG. 6B illustrate example signals and operations for sensing session continuity when an Xn based handover occurs. The sensing admission control procedure is performed at the target RAN. This procedure is applied for both bi-static sensing methods: RAN (Tx) and UE (Rx); and UE (Tx) and RAN (Rx). As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

While sensing is being executed during operation 600, at operation 601, the UE transmits to the source RAN (i.e., the serving RAN) a measurement report, based on a condition being satisfied (e.g., the radio quality of a neighbor cell(s) is better than the radio quality of the serving cell of the source RAN).

At operation 602, the source RAN makes a handover determination.

At operation 603, the source RAN transmits to a target RAN (e.g., a target network node) a handover request message. The target RAN receives the request message from the source RAN. The handover request message may include information about the sensing configurations of both UE and RAN entity, including one or more of the following: sensing session identifier(s), sensing resources configuration, sensing session configuration, and/or sensing data reporting configuration. As used herein, the term “sensing configurations” refers to and includes one or more of: sensing resource configuration, sensing session configuration, or sensing data reporting configuration.

Sensing session identifier(s) may be used to uniquely identify and coordinate sensing operations among different entities as well as for transmitting sensing measurements/data from network node(s) to the SeMF, that belong to the same sensing service procedure and/or request.

Sensing resources configuration may include information about user plane and/or control plane resources used for sensing at the source RAN entity e.g., resource blocks, time or frequency resources, and/or a selected frequency band assigned for physical downlink shared channel (PDSCH) to deliver control-plane/user-plane (C/U-plane) data.

Sensing Session Configuration may include information about the requirements and the configuration of the sensing session and specifically that is relevant with the role of the UE that assists in the sensing procedure, including one or more of the following: sensing QoS e.g., sensing accuracy, sensing resolution, sensing delay; sensing method used; indication of the Sensing Tx Role and/or Sensing Rx Role of the UE that assists in the sensing procedure; sensing type, sensing area, sensing duration, and/or sensing update rate; and/or Service SeMF ID.

Sensing data reporting configuration may include information about control plane-based reporting or user plane-based reporting (e.g., to or via dedicated server) used to transfer the sensing measurements (/sensing data) from the network node to SeMF. Information on required requirements, resources, and configurations for the sensing data reporting may be included.

At operation 604, the target RAN performs admission control for sensing as part of decision of handover acceptance, using the sensing configuration information included in the handover request message.

At operation 605, the target RAN transmits to the source RAN a handover request acknowledgement message (ACK). The source RAN receives from the target RAN the handover request acknowledgement message.

The handover request acknowledgement message may include the list of accepted or not accepted sensing session IDs. In the case of not accepting one or more Sensing Session IDs, then the handover request acknowledgement message contains a cause value to enable the UE and/or the SeMF to know the reason for the unsuccessful establishment. The target network node can provide (new or updated) sensing resources configuration (e.g., control plane resources used for sensing at the source RAN, e.g., resource blocks, time or frequency resources, selected frequency band), sensing session configuration, and/or sensing data reporting configuration, to the UE that has the role of transmitter or receiver of sensing signals. In embodiments, the new or updated configurations may be provided as delta configurations that indicate changes to an existing configuration. This will help to ensure sensing service continuity to ensure that e.g., the transmission of sensing signals from the UE will not be interrupted during the handover from one network node to another.

The source RAN buffers sensing data. At operation 606, the source RAN transmits to the target RAN the buffered sensing data and the target RAN receives from the source RAN the buffered sensing data.

At operation 607, handover to the target RAN is executed between UE and target RAN.

At operation 608, the target RAN transmits to the AMF a path switch request which may include the list of accepted or not accepted sensing session IDs and updated configurations of sensing resource, session, and/or data reporting if exists, e.g., as delta configurations. The AMF receives the path switch request from the target RAN.

At operation 609, the AMF transmits the path switch request message acknowledgement (or a new dedicated message) to the target RAN.

At operation 610, the AMF transmits to the SeMF a notification message that indicates that a handover has occurred for a given UE ID including the list of accepted or not accepted sensing session IDs and updated configurations of sensing resource, session and data reporting if exists, e.g., as delta configurations. The notification message may include one or more of the following: Session ID, Sensing assisted UE ID, Source network node ID, Target network node ID(s), Sensor ID (if available), which describes the Tx entity and Rx entities that participates to the specific session ID.

In case of “failure/not accepted” of a handover request message then the cause can be included.

At operation 611, the target RAN transmits to the source RAN a UE context release message. The source RAN receives the UE context release message from the target RAN.

At operation 612, upon receiving the UE context release, the source RAN stops forwarding the buffered sensing data as well as releases all sensing configurations as part of UE context. The source RAN stops sending and receiving sensing signals still being transmitted.

At operation 613, the SeMF optionally determines whether an update of the sensing session(s) and sensing configuration(s) is needed if some of the current sessions/configurations are not suitable to the target RAN, e.g., due to target RAN capabilities, resources etc. Accordingly, the SeMF provides sensing configuration information to target RAN, and/or to the UE.

At operation 614, sensing service continues via the target RAN.

The operations of FIG. 6A and FIG. 6B are merely illustrative, and variations are contemplated to be within the scope of the present disclosure. In embodiments, the operations may include others not illustrated in FIG. 6A and FIG. 6B. In embodiments, the operations may not include every signal and operation illustrated in FIG. 6A and FIG. 6B. In embodiments, the operations may be implemented in a different order than that illustrated in FIG. 6A and FIG. 6B. Such and other embodiments are contemplated to be within the scope of the present disclosure.

FIG. 7A and FIG. 7B illustrate an exemplary method for supporting sensing session continuity in the case of an inter NG-RAN node N2 based handover.

Referring now to FIG. 7A and FIG. 7B, example signals and operations are shown in relation to an inter NG-RAN node N2 based handover procedure. As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

The sensing admission control procedure is performed at the target RAN. This method may be applied for both bi-static sensing methods: RAN (Tx) and UE (Rx); and UE (Tx) and RAN (Rx). A difference from the Xn base handover in FIG. 6A and FIG. 6B is that the handover preparation in FIG. 7A and FIG. 7B is conducted between the source RAN and the target RAN via AMF, as in operations 703, 704, 706 and 707. Upon receiving the handover request acknowledgement in operation 706, the AMF identifies the sensing sessions accepted or not accepted by Target RAN from the list of accepted/not accepted sensing session IDs and updated configurations of sensing resource, session and data reporting if exists, e.g., as delta configurations. The AMF includes the list of accepted or not accepted sensing session ID(s), cause value in case of failure (i.e., not accepted) and/or (updated) sensing configurations in the handover command message transmitted to the source RAN node in operation 707. Upon the notification of HO completion in operation 710 (i.e., handover notify from the target RAN), the AMF notifies the SeMF that a handover has occurred with the list of accepted/not accepted sensing session IDs and updated configurations of sensing resource, session and data reporting if exists in operation 811.

Operations 700-702 are the same as operations 600-602 of FIG. 6A and FIG. 6B.

At operation 703, the source RAN transmits to the AMF a message indicating that a handover is required. The AMF receives the request message from the source RAN. The handover request message may include information about the sensing configurations of both UE and RAN entity, including one or more of the following: sensing session identifier(s), sensing resources configuration, sensing session configuration, and/or sensing data reporting configuration.

At operation 704, the AMF transmits to a target RAN (e.g., a target network node) a handover request message. The target RAN receives the request message from the AMF. The handover request message may include information about the sensing configurations of both UE and RAN entity, including one or more of the following: sensing session identifier(s), sensing resources configuration, sensing session configuration, and/or sensing data reporting configuration.

At operation 705, the target RAN performs sensing admission control procedure.

At operation 706, the target RAN transmits to the AMF a handover request acknowledgement message (ACK). The AMF receives from the target RAN the handover request acknowledgement message. The handover request acknowledgement message may include the list of accepted or not accepted sensing session IDs. In the case of not accepting one or more Sensing Session IDs then the handover request acknowledgement message may contain a cause value to enable the UE and/or the SeMF to know the reason for the unsuccessful establishment. The target network node can provide (new or updated) sensing resources configuration (e.g., control plane resources used for sensing at the source RAN, e.g., resource blocks, time or frequency resources, selected frequency band), sensing session configuration, and/or sensing data reporting configuration, to the UE that has the role of transmitter or receiver of sensing signals. In embodiments, the new or updated configurations may be provided as delta configurations that indicate changes to an existing configuration. This will help to ensure sensing service continuity to ensure that e.g., the transmission of sensing signals from the UE will not be interrupted during the handover from one network node to another. Sensing configurations at source RAN are transferred from AMF to target RAN.

At operation 707, the AMF transmits to the source RAN a handover command message. The source RAN receives the handover command from the AMF. The handover command message may include information about the sensing configurations of both UE and RAN entity, including one or more of the following: sensing session identifier(s), sensing resources configuration, sensing session configuration, and/or sensing data reporting configuration.

At operation 708, the source RAN buffers sensing data.

In various embodiments, the source RAN may transmit to the target RAN buffered sensing data. The target RAN receives the buffered sensing data from the source RAN.

At operation 709, handover to the target RAN is executed between UE and target RAN.

At operation 710, the target RAN transmits to the AMF a handover notification message. The AMF receives the handover notification message from the target RAN.

At operation 711, the AMF transmits to the SeMF a notification message that indicates that a handover has occurred for a given UE ID. The SeMF receives from the AMF the notification message. The message includes the list of accepted or not accepted sensing session IDs and updated configurations of sensing resource, session and data reporting if exists, e.g., as delta configurations. The notification message may include one or more of the following: Session ID, Sensing assisted UE ID, Source network node ID, Target network node ID(s), Sensor ID (if available), which describes the Tx entity and Rx entities that participates to the specific session ID.

In case of “failure/not accepted” of a handover request message then the cause can be included.

At operation 712, the target RAN transmits to the source RAN a UE context release command message. The source RAN receives the UE context release command message from the target RAN.

At operation 713, upon receiving the UE context release, the source RAN stops forwarding the buffered sensing data as well as releases all sensing configurations as part of UE context. The source RAN stops sending and receiving sensing signals still being transmitted.

At operation 714, the source RAN transmits to the AMF a UE context release message. The AMF receives the UE context release message from the source RAN.

At operation 715, the SeMF optionally determines whether an update of the sensing session(s) and sensing configuration(s) is needed if some of the current sessions/configurations are not suitable to the target RAN entity e.g., due to target RAN entity capabilities, resources etc. Accordingly, the SeMF provides sensing configuration information to target RAN, and/or to the UE.

At operation 716, sensing service continues at the target RAN.

The operations of FIG. 7A and FIG. 7B are merely illustrative, and variations are contemplated to be within the scope of the present disclosure. In embodiments, the operations may include others not illustrated in FIG. 7A and FIG. 7B. In embodiments, the operations may not include every signal and operation illustrated in FIG. 7A and FIG. 7B. In embodiments, the operations may be implemented in a different order than that illustrated in FIG. 7A and FIG. 7B. Such and other embodiments are contemplated to be within the scope of the present disclosure.

FIG. 8A, FIG. 8B, and FIG. 8C illustrate an exemplary method for supporting sensing session continuity in the case of in case of inter NG-RAN node N2 based handover with AMF relocation.

Referring now to FIG. 8A, FIG. 8B, and FIG. 8C, example signals and operations are shown in relation to an inter NG-RAN node N2 based handover procedure. As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

FIG. 8A, FIG. 8B, and FIG. 8C illustrate an exemplary procedure for supporting sensing session continuity in the case where an inter NG-RAN node N2 based handover occurs and the AMF is relocated during the handover. The sensing admission control procedure is performed at the SeMF. This procedure is applied for both bi-static sensing methods: RAN (Tx) and UE (Rx); and UE (Tx) and RAN (Rx).

Operations 800 to 802 are the same as operations 600-602 of FIG. 6A and FIG. 6B.

In various embodiments, the source RAN buffers sensing data.

At operation 803, the source RAN transmits to the source AMF a message indicating that a handover is required. The source AMF receives the request message from the source RAN. The handover request message may include all the sensing configurations for both UE and RAN, e.g., sensing session ID, sensing configuration, and/or sensing QoS.

At operation 804, the source AMF performs target AMF selection.

At operation 805, the source AMF transmits to the target AMF the sensing configurations from the source RAN. The target AMF receives the sensing configurations from the source AMF.

At operation 806, the target AMF transmits to the SMF the sensing configurations. The SMF receives the sensing configurations from the target AMF.

At operation 807, the SMF performs UPF selection.

At operation 808, the SeMF transmits to the target SMF an Nsmf_PDUSession_UpdateSMContext service response. The target SMF receives the response from the SeMF.

At operation 809, the target AMF transmits to the target RAN a handover request. The target RAN receives the handover request from the target AMF. For example, upon the Nsmf_PDUSession_UpdateSMContext service operation is completed (operations 806 to 808), the target RAN may invoke the handover request, which may include the sensing configurations.

At operation 810, the target RAN performs sensing admission control procedure.

At operation 811, the target RAN transmits to the target AMF a handover request ACK. The target AMF receives the handover request acknowledgement from the target RAN. For example, upon sensing admission control procedure at target RAN (operation 910), the handover request acknowledgement including the list of accepted/not accepted sensing session IDs and updated configurations of sensing resource, session and data reporting if exists may be sent to target AMF.

At operations 812 and 813, Nsmf_PDUSession_UpdateSMContext service operation is completed.

At operation 814, the sensing sessions accepted or not accepted by target RAN from the list of accepted/not accepted sensing session IDs and updated configurations of sensing resource, session and data reporting is forwarded from the target AMF to the source AMF. The source AMF receives the sensing sessions from the target AMF. The message includes the list of accepted or not accepted sensing session ID(s), cause value in case of failure (i.e., not accepted) and/or (new or updated) sensing configurations in the handover command message transmitted to the source RAN in operation 815.

At operation 815, the source AMF transmits to the source RAN a handover command message. The source RAN receives the handover command from the AMF. The handover command message may include information about the sensing configurations of both UE and RAN entity, including one or more of the following: sensing session identifier(s), sensing resources configuration, sensing session configuration, and/or sensing data reporting configuration.

At operation 816, the source RAN may transmit to the target RAN buffered sensing data. The target RAN receives the buffered sensing data from the source RAN.

At operation 817, handover to the target RAN is executed between UE and target RAN.

At operation 818, the target RAN transmits to the target AMF a handover notification message. The target AMF receives the handover notification message from the target RAN.

At operation 819, the target AMF transmits the Namf_Communication_N2InfoNotify acknowledgement message to the target SMF. The SMF receives the Namf_Communication_N2InfoNotify acknowledgement message from the target SMF.

At operation 820 source AMF transmits the Namf_Communication_N2InfoNotify acknowledgement message to the target AMF. The target AMF receives transmits the Namf_Communication_N2InfoNotify acknowledgement message from the source AMF. Operations 821-822 are similar to operations 812-813.

At operation 823, upon the completion of the Nsmf_PDUSession_UpdateSMContext service operation after the handover execution, target AMF notifies to SeMF that handover has occurred with the list of accepted/not accepted sensing session IDs.

At operation 824, the source AMF transmits to the source RAN a UE context release message. The source RAN receives the UE context release message from the source AMF.

At operation 825, upon receiving the UE context release, the source RAN stops forwarding the buffered sensing data as well as releases all sensing configurations as part of UE context. The source RAN stops sending and receiving sensing signals still being transmitted.

At operation 826, the source RAN transmits to the source AMF a UE context release complete message. The source AMF receives the UE context release complete message from the source RAN.

At operation 827, the SeMF optionally determines whether an update of the sensing session(s) and sensing configuration(s) is needed if some of the current sessions/configurations are not suitable to the target RAN entity e.g., due to target RAN entity capabilities, resources etc. Accordingly, the SeMF provides sensing configuration information to target RAN, and/or to the UE.

At operation 828, the sensing service continues at the target RAN.

The operations of FIG. 8A, FIG. 8B, and FIG. 8C are merely illustrative, and variations are contemplated to be within the scope of the present disclosure. In embodiments, the operations may include others not illustrated in FIG. 8A, FIG. 8B, and FIG. 8C. In embodiments, the operations may not include every signal and operation illustrated in FIG. 8A, FIG. 8B, and FIG. 8C. In embodiments, the operations may be implemented in a different order than that illustrated in FIG. 8A, FIG. 8B, and FIG. 8C. Such and other embodiments are contemplated to be within the scope of the present disclosure.

Referring now to FIG. 9A and FIG. 9B, example signals and operations are shown in relation to Xn based handover procedure. As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

FIG. 9A and FIG. 9B illustrate an exemplary procedure for supporting sensing session continuity in the case of an Xn based handover where the sensing admission control procedure is performed at the SeMF. This procedure is applied for both bi-static sensing methods: RAN (Tx) and UE (Rx); and UE (Tx) and RAN (Rx).

Operations 900-902 are the same as operations 600-602 of FIG. 6A and FIG. 6B.

At operation 903, the source RAN entity sends a handover request message to target RAN. The handover request message includes all the sensing configurations for both UE and RAN, e.g., sensing session ID, sensing configuration, sensing QoS, etc.

Operations 904-907, are the same as operations 604-607 of FIG. 6A and FIG. 6B.

At operation 908, the target RAN transmits to the AMF a path switch request message. The path switch request message includes all the sensing configurations received in operation 903. The AMF receives from the target RAN path switch request message.

At operation 909, AMF transmits to the SeMF a message indicating that handover has occurred for a given UE including the sensing configurations received in operation 907.

At operation 910, the SeMF performs admission control for sensing.

At operation 911, the SeMF transmits to the AMF a reply. The reply includes the list of accepted or not accepted sensing session IDs. In addition, (new or updated) sensing resources, session, and data reporting configurations can be provided, e.g., as delta configurations (similar to operation 605 of FIG. 6A and FIG. 6B).

At operation 912, the AMF transmits to the target RAN a path switch request acknowledgement. The target RAN receives from the AMF path switch request acknowledgement. The path switch request acknowledgement includes the list of accepted or not accepted sensing session IDs and if available (e.g., new or updated) sensing configurations can be provided (similar to operation 605 of FIG. 6A and FIG. 6B), e.g., as delta configurations.

At operation 915, optionally the SeMF may update sensing sessions and configurations in a case where some of the current sessions/configurations are not suitable to the target RAN.

At operation 916, the sensing service continues at the target RAN.

In another example embodiment relating to operations 908 to 912 (i.e., the interaction between the target RAN node and the SeMF for the sensing admission control procedure) can take place before the handover request acknowledgement message (operation 905). The target RAN node should wait for the outcome of the sensing admission control procedure before transmitting the handover request acknowledgement message. In addition, this behavior at the target RAN node (i.e., wait for SeMF admission control) could be enabled by a flag in the handover request message and/or by indication where the sensing configuration and/or admission control takes place.

The operations of FIG. 9A and FIG. 9B are merely illustrative, and variations are contemplated to be within the scope of the present disclosure. In embodiments, the operations may include others not illustrated in FIG. 9A and FIG. 9B. In embodiments, the operations may not include every signal and operation illustrated in FIG. 9A and FIG. 9B. In embodiments, the operations may be implemented in a different order than that illustrated in FIG. 9A and FIG. 9B. Such and other embodiments are contemplated to be within the scope of the present disclosure.

Referring now to FIG. 10A and FIG. 10B, example signals and operations are shown in relation to inter NG-RAN node N2 based handover procedure. As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

FIG. 10A and FIG. 10B illustrate an exemplary procedure for supporting sensing session continuity in the case of an inter NG-RAN node N2 based handover where the sensing admission control procedure is performed at the SeMF. This procedure is applied for both bi-static sensing methods: RAN (Tx) and UE (Rx); and UE (Tx) and RAN (Rx).

Operations 1000-1002 are the same as operations 700-702 of FIG. 7A and FIG. 7B.

At operations 1003 and 1004, the source RAN transmits to the target RAN via AMF all the sensing configurations for both UE and RAN, e.g., the sensing session ID, sensing configuration, sensing QoS, etc. The target RAN receives from the source RAN the sensing configurations.

Operations 1005-1009 are the same as operations 705-709 of FIG. 7A and FIG. 7B.

At operation 1010, the target RAN transmits to the AMF a handover notification message. The AMF receives the handover notification message from the target RAN. The handover notify message conveys the sensing session IDs established at the source RAN.

At operation 1011, the AMF transmits to the SeMF a notification message that indicates that a handover has occurred for a given UE ID. The SeMF receives from the AMF the notification message. The message includes the list of accepted or not accepted sensing session IDs and updated configurations of sensing resource, session and data reporting if exists, e.g., as delta configurations. The notification message may include one or more of the following: Session ID, Sensing assisted UE ID, Source network node ID, Target network node ID(s), Sensor ID (if available), which describes the Tx entity and Rx entities that participates to the specific session ID. The sensing session IDs established at the source RAN are forwarded to SeMF.

At operation 1012, the SeMF performs sensing admission control procedure.

At operation 1013, the SeMF transmits to the target RAN the accepted/rejected sensing session IDs via the AMF. In addition, (new or updated) sensing resources, session, and data reporting configurations can be provided, e.g., as delta configurations (similar to operation 605 of FIG. 6A and FIG. 6B).

Operation 1014 is the same as operation 712 of FIG. 7A and FIG. 7B.

At operation 1015, upon receiving the UE context release, the source RAN stops forwarding the buffered sensing data as well as releases all sensing configurations as part of UE context. The source RAN stops sending and receiving sensing signals still being transmitted.

Operations 1016-1018 are the same as operations 714-716 of FIG. 7A and FIG. 7B.

In another example embodiment, at operations 1010-1013 (i.e., the interaction between the target RAN and the SeMF for the sensing admission control procedure) may take place before the handover request acknowledgement message (operation 1006). This means that the target RAN should wait for the outcome of the sensing admission control procedure before transmitting the handover request acknowledgement message. In addition, this behavior at the target RAN (i.e., wait for SeMF admission control) could be enabled by a flag in the handover request message and/or by indication where the sensing configuration and/or admission control takes place.

The operations of FIG. 10A and FIG. 10B are merely illustrative, and variations are contemplated to be within the scope of the present disclosure. In embodiments, the operations may include others not illustrated in FIG. 10A and FIG. 10B. In embodiments, the operations may not include every signal and operation illustrated in FIG. 10A and FIG. 10B. In embodiments, the operations may be implemented in a different order than that illustrated in FIG. 10A and FIG. 10B. Such and other embodiments are contemplated to be within the scope of the present disclosure.

Referring now to FIG. 11A, FIG. 11B, and FIG. 11C, example signals and operations are shown in relation to inter NG-RAN node N2 based handover procedure. As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

FIG. 11A, FIG. 11B, and FIG. 11C illustrate an exemplary procedure for supporting sensing session continuity in the case of an inter NG-RAN node N2 based handover is occurred and AMF is relocated during the handover.

Operations 1100-1108 are the same as operations 800-808 of FIG. 8A, FIG. 8B, and FIG. 8C.

At operation 1109, the target AMF transmits the handover request message to the target RAN. The target RAN receives the handover request message from the target AMF. For example, upon the Nsmf_PDUSession_UpdateSMContext service operation completion (operations 1106-1108), the target AMF invokes the handover request which includes the sensing configurations.

At operation 1110, the target RAN performs admission control, except for sensing.

Operations 1110-1123 are the similar to operations 810-823 of FIG. 8A, FIG. 8B, and FIG. 8C. The sensing sessions accepted or not accepted by Target RAN entity from the list of accepted/not accepted sensing session IDs and updated configurations of sensing resource, session and data reporting, e.g., as delta configurations, are forwarded to the source RAN. At operation 1122, upon the completion of the Nsmf_PDUSession_UpdateSMContext service operation after the handover execution, target AMF notifies to SeMF that handover has occurred with the list of sensing session IDs established at source RAN.

At operation 1124, the SeMF performs sensing admission control procedure.

At operation 1125, the SeMF transmits to the target RAN a message indicating the accepted/rejected sensing session IDs, the delta configuration of the sensing resource, and the session and data reporting.

Operations 1126-1130 are the same as operations 824-824 of FIG. 8A, FIG. 8B, and FIG. 8C, respectively. At operation 1129, the SeMF may update sensing sessions and configurations in a case where some of the current sessions/configurations are not suitable to the target RAN. At operation 1130, the sensing service continues at the target RAN.

The operations of FIG. 11A, FIG. 11B, and FIG. 11C are merely illustrative, and variations are contemplated to be within the scope of the present disclosure. In embodiments, the operations may include others not illustrated in FIG. 11A, FIG. 11B, and FIG. 11C. In embodiments, the operations may not include every signal and operation illustrated in FIG. 11A, FIG. 11B, and FIG. 11C. In embodiments, the operations may be implemented in a different order than that illustrated in FIG. FIG. 11A, FIG. 11B, and FIG. 11C. Such and other embodiments are contemplated to be within the scope of the present disclosure.

Referring now to FIG. 12A, FIG. 12B, and FIG. 12C, example signals and operations are shown in relation to an Xn based handover where the sensing admission control procedure is performed at the SeMF. As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

FIG. 12A, FIG. 12B, and FIG. 12C illustrate an exemplary procedure for supporting sensing session continuity in the case of an Xn based handover where the sensing admission control procedure is performed at the SeMF. The key difference from FIG. 9A and FIG. 9B is that sensing admission control procedure and configuration decision are made upon handover occurrence is notified by AMF in operation 1210.

Operations 1200-1209 are the same as operations 900-909 of FIG. 9A and FIG. 9B.

Operations 1210, 1211, 1213, and 1214 are the same as operations 911, 912, 914, and 910 of FIG. 9A and FIG. 9B, respectively. At operation 1215 the SeMF determines the sensing configuration. In embodiments, in a case where sensing admission control procedure (operation 1214) and configuration decision (operation 1215) concludes some configurations of the current sensing session are updated by the SeMF.

At operation 1216, the SeMF transmits to the target RAN the sensing session update request (via the AMF). The target RAN receives from the SeMF the sensing session update request. The sensing session update request may include the list of accepted or rejected sensing session IDs, updated configurations of sensing resource, sensing session and sensing data reporting

At operation 1217, the target RAN transmits to the UE a reconfiguration of UE sensing configuration message which includes updated Sensing Tx or Rx configuration. The UE receives from the target RAN the reconfiguration of UE sensing configuration message.

At operation 1218, the UE validates and apply the updated configuration if it is compliant with UE sensing capability.

At operation 1219, the UE transmits to the target RAN a reconfiguration response. The target RAN receives the reconfiguration response from the UE.

At operation 1220, the Target RAN transmits to the SeMF a sensing session update response (via the AMF). The sensing session update response includes an indication of whether the request is accepted or rejected with reasoning.

Operation 1221 is the same as operations 916 of FIG. 9A and FIG. 9B.

The operations of FIG. 12A, FIG. 12B, and FIG. 12C are merely illustrative, and variations are contemplated to be within the scope of the present disclosure. In embodiments, the operations may include others not illustrated in FIG. 12A, FIG. 12B, and FIG. 12C. In embodiments, the operations may not include every signal and operation illustrated in FIG. 12A, FIG. 12B, and FIG. 12C. In embodiments, the operations may be implemented in a different order than that illustrated in FIG. 12A, FIG. 12B, and FIG. 12C. Such and other embodiments are contemplated to be within the scope of the present disclosure.

Referring now to FIG. 13A, FIG. 13B, and FIG. 13C, example signals and operations are shown in relation to inter NG-RAN node N2 based handover with AMF relocation, which also covers the non-AMF relocation case. As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

FIG. 13A, FIG. 13B, and FIG. 13C illustrate an exemplary procedure for supporting sensing session continuity in the case of an inter NG-RAN node N2 based handover with AMF relocation, which also covers the non-AMF relocation case where the sensing admission control procedure is performed at the SeMF.

Mobility of the sensing assisting UE, may lead to the case that the original serving SeMF is not suitable. For example, the serving SeMF may be far from the target RAN (e.g., in terms of delay, distance, RTT) or new serving AMF, which leads to higher resource utilization for the target RAN or the AMF to SeMF signaling, or the SeMF may not be configured with information (e.g., a cell database) for the current access network for the UE to enable sensing services. In such a case, the serving SeMF may need to change.

Operations 1300-1323 are the same as operations 1100-1123 of FIG. 11A, FIG. 11B, and FIG. 11C.

At operation 1324, the SeMF transmits the Namf_Sensing_EventNotify acknowledgement message to the target AMF. The target AMF receives the Namf_Sensing_EventNotify acknowledgement message from the SeMF.

Operation 1325 is the same as operation 1124 of FIG. 11A, FIG. 11B, and FIG. 11C.

At operation 1326, the SeMF determines the sensing configuration.

Operations 1327-1330 are the same as operations 1127-1130 of FIG. 11A, FIG. 11B, and FIG. 11C.

The operations of FIG. 13A, FIG. 13B, and FIG. 13C are merely illustrative, and variations are contemplated to be within the scope of the present disclosure. In embodiments, the operations may include others not illustrated in FIG. 13A, FIG. 13B, and FIG. 13C. In embodiments, the operations may not include every signal and operation illustrated in FIG. 13A, FIG. 13B, and FIG. 13C. In embodiments, the operations may be implemented in a different order than that illustrated in FIG. 13A, FIG. 13B, and FIG. 13C. Such and other embodiments are contemplated to be within the scope of the present disclosure.

Referring now to FIG. 14A and FIG. 14B, example signals and operations are shown in relation to supporting sensing session continuity in the case of relocation of the serving SeMF. As mentioned above, the terms “transmit to”, “receive from”, and “cooperate with” (and their variations), include communications that may or may not involve communications through one or more intermediate devices or nodes.

The following paragraphs describe various signals and operations. It will be understood that the described signals may have associated operations and the described operations may have associated signals. Accordingly, a described signal may also involve an operation and a described operation may also involve a signal.

FIG. 14A and FIG. 14B illustrate an exemplary procedure for supporting sensing session continuity in the case of relocation of the serving SeMF.

While sensing is being executed during operation 600, At operation 601 the UE transmits to the source RAN (i.e., the serving RAN) a measurement report, based on a condition being satisfied (e.g., the radio quality of a neighbor cell(s) is better than the radio quality of the serving cell of the source RAN).

At operation 1401, handover to the RAN is executed between UE and the RAN.

At operation 1402, based on the operator's configuration and policy, the AMF may evaluate and determine that the source SeMF is unsuitable or unable to support sensing for the current UE access network or serving cell and determines a target SeMF as being a more suitable SeMF. AMF may already have target SeMF information e.g., from the previous NRF discovery or locally configured, otherwise the AMF queries the NRF and in response may get a set of SeMF profiles. The AMF selects a target SeMF for the current UE location based on SeMF service area (e.g., consisting of one or more TA(s)) and also other information needed for SeMF selection.

At operation 1403, the AMF transmits to the source SeMF the Namf_Sensing_EventNotify message. The source SeMF receives the Namf_Sensing_EventNotify message from the AMF. If AMF determined a target SeMF in operation 1402, AMF indicates it in this operation, as well as the even triggered for this operation (i.e., handover in this case).

At operation 1404, in a case where the AMF did not indicate a target SeMF in operation 1402, based on the operator configuration and policy, the serving SeMF may evaluate and determine that it is unsuitable or unable to support sensing for the current UE access network or serving cell and determines target SeMF as being a more suitable SeMF. The serving SeMF may already have target SeMF information e.g., from previous NRF discovery or locally configured, otherwise the serving SeMF queries NRF and in response may get a set of SeMF profiles. The serving SeMF selects a target SeMF for the current UE location based on SeMF service area (e.g., consisting of one or more TA(s)) and other information needed for SeMF selection.

At operation 1405, the serving SeMF transmits to the target SeMF an Nsemf_Sensing_SensingContextTransfer request message to provide the current sensing context for UE and RAN. The serving SeMF receives from the target SeMF the Nsemf_Sensing_SensingContextTransfer request message.

At operation 1406, the target SeMF transmits to the AF or the NEF a Nsemf_SensingEventNotify message and informs AF or the NEF that SeMF is relocated with a new target SeMF information.

At operation 1407, the AF or the NEF transmit to the target SeMF a Nsem_SensingEventNotify acknowledgement message. The target SeMF receives the Nsem_SensingEventNotify acknowledgement message from the AF or the NEF.

At operation 1408, the target SeMF transmits to the source SeMF the sensing context transfer operation results, indicating the acceptance or not of the transfer. In the case of successful transfer, the source SeMF then releases all sensing contexts for the transferred sensing session. The source SeMF receives from the target SeMF the sensing context transfer operation results.

At operation 1409, the target SeMF transmits to the AMF a Namf_SensingEventNotify acknowledgement message. The acknowledgement message indicates the change of SeMF. The AMF receives the acknowledgement message from the target SeMF.

At operation 1410, the Sensing procedure continues at the target RAN entity.

In an example embodiment relating to 6G Architecture, with regards to the need of SeMF relocation, the source and/or target RAN entity evaluate and determine that the serving SeMF is unsuitable or unable to support sensing operations/procedures for the current UE access network or serving cell. The RAN may directly communicate with 6G core network functions e.g., without involving AMF.

Each RAN entity is associated with one or more SeMF. Thus, once the source or target RAN entity identify the target handover peer, the need of SeMF can be determined. RAN entity is aware of the associated SeMF for each neighbor RAN entity. In this case, the source or target RAN entity directly requests the SeMF to relocate the SeMF.

In another example embodiment, the sensing context that the serving SeMF provides to the target SeMF (in operation 1405) may include one or more of the following information: Sensing Context information for the case that a RAN node (e.g., network node) transmits a sensing signal and UE(s) receives it to obtain a sensing data; and/or Sensing Context information for the case that the UE transmits a sensing signal and one or more RAN nodes (e.g., network node) receives it to obtain a sensing data

The Sensing Context information for the case that a RAN node (e.g., network node) transmits a sensing signal and UE(s) receives it to obtain a sensing data may include, for example, Sensing Session ID, Sensing QoS, Sensor ID #1, Sensor ID #2. The Sensor ID #1 may include: Sensing Method, Sensing Capabilities of Sensor ID #1, Sensing Tx role: network node ID, Cell ID, Tx Sensing Session Configuration of Sensor network node ID/Cell ID, Tx Sensing Resources Configuration of Sensor network node ID/Cell ID, and/or Sensing Data Reporting configuration of Tx Sensor network node ID(s)/Cell ID(s); Sensing Rx role: UE ID, Rx Sensing Session Configuration of UE ID, Rx Sensing Resources Configuration of UE ID, and/or Sensing Data Reporting configuration of Rx UE ID.

Sensing Context information for the case that the UE transmits a sensing signal and one or more RAN nodes (e.g., network node) receives it to obtain a sensing data may include Sensing Session ID, which may include Sensing QoS and Sensor ID #1. Sensor ID #1 may include Sensing Method, Sensing Capabilities of Sensor ID #1, Sensing Tx role, and/or Sensing Rx role. Sensing Tx role may include UE ID, Tx Sensing Session Configuration of UE ID, Tx Sensing Resources Configuration of UE ID, and/or Sensing Data Reporting configuration of Tx UE ID. The Sensing Rx role may include network node ID, Cell ID, Rx Sensing Session Configuration of Sensor network node ID/Cell ID, Rx Sensing Resources Configuration of Sensor network node ID/Cell ID, and/or Sensing Data Reporting configuration of Rx Sensor network node ID(s)/Cell ID(s). Although Sensor ID #1 was used as an example, additional Sensor ID #'s would include similar fields of information as Sensor ID #1.

The operations of FIG. 14A, FIG. 14B, and FIG. 14C are merely illustrative, and variations are contemplated to be within the scope of the present disclosure. In embodiments, the operations may include others not illustrated in FIG. 14A, FIG. 14B, and FIG. 14C. In embodiments, the operations may not include every signal and operation illustrated in FIG. 14A, FIG. 14B, and FIG. 14C. In embodiments, the operations may be implemented in a different order than that illustrated in FIG. 14A, FIG. 14B, and FIG. 14C. Such and other embodiments are contemplated to be within the scope of the present disclosure.

Accordingly, the figures and descriptions disclose aspects performed by various entities to provide sensing continuing in case of handover. The following will describe aspects from the perspective of various entities.

From the perspective of a RAN, the RAN may perform one or more of the following:
Include Sensing Session Information (i.e., Sensing Session Identifier, Sensing Resources Configuration, Sensing Session Configuration, Sensing Data Reporting configuration) in the Handover Request message transmitted from the Source RAN node or the AMF to the target RAN entity.
Include Sensing Session Information (i.e., Sensing Session Identifier, Sensing Resources Configuration, Sensing Session Configuration, Sensing Data Reporting configuration) in the Handover Required message transmitted from the Source RAN node to the serving AMF.
(Target RAN node) Conduct Sensing admission control procedure, using the content of the Handover Request message.
extend the Path switch request message or another dedicated message that is sent from the Target RAN node to the AMF to inform about the Handover including one or more of the following:
   the list of accepted or not accepted sensing session IDs (in case Sensing admission control procedure takes place at the RAN node)
   the sensing configurations received by the Handover Request message (in case the in case Sensing admission control procedure takes place at the SeMF or another NF)
(Target RAN node) Include Sensing Session Information on Sensing Session Identifier, Sensing Resources Configuration, Sensing Session Configuration, Sensing Data Reporting configuration in the Handover Request ACK message transmitted from the Source RAN node to the target RAN entity.
Include the list of accepted or not accepted sensing session ID(s), cause value in case of failure (i.e., not accepted) and/or (new) sensing resources configuration in the Handover Request Acknowledgement message from the Target RAN node to the source RAN node or the AMF.
Include the list of accepted or not accepted sensing session ID(s), cause value in case of failure (i.e., not accepted) and/or (new) sensing resources configuration in the Handover Command message transmitted from the AMF to the Source RAN node.
(Optionally suppose that RAN node can communicate with SeMF w/o any intermediaries, e.g., AMF as in 5G System) can Transmit notification message to the SeMF that a handover has occurred (or triggered) for a given UE ID including one or more of the following:
   list of accepted or not accepted sensing session IDs (in case Sensing admission control procedure takes place at the RAN node),
   UE ID(s) that assist/participate a sensing service,
   includes the sensing configurations received by the RAN node e.g., via the handover Request message (in case the Sensing admission control procedure takes place at the SeMF or another NF).
Include sensing data forwarding from source RAN to target RAN during handover.
   In case of N2-based HO, sensing data forwarding is done by directly between RAN nodes or indirectly via UPF, whereas sensing data is directly forwarded between RAN nodes in case of Xn-based HO.

From the perspective of an AMF, the AMF may perform one or more of the following:
extend the Path switch ACK message or another (new) dedicated message for the response on the Handover notification that is sent from the AMF to the RAN node including one or more of the following:
   list of accepted or not accepted sensing session IDs
   cause value in case of failure (i.e., not accepted Session ID)
   and/or (new) sensing resources configuration
Include the list of accepted or not accepted sensing session ID(s), cause value in case of failure (i.e., not accepted) and/or (new) sensing resources configuration in the Handover Command message transmitted from the AMF to the Source RAN node.
Transmit notification message to the SeMF that a handover has occurred (or triggered) for a given UE ID including one or more of the following:
   list of accepted or not accepted sensing session IDs (in case Sensing admission control procedure takes place at the RAN node)
   UE ID(s) that assist/participate a sensing service,
   includes the sensing configurations received by the RAN node e.g., via the handover Request message (in case the Sensing admission control procedure takes place at the SeMF or another NF).
   New Service SeMF, if needed.

From the perspective of a SeMF, the SeMF may perform one or more of the following:
Update Sensing Session configuration during the handover preparation upon request or event by a RAN node and/or AMF
Update Sensing Session configuration after the handover execution upon request or event by a RAN node and/or AMF
Conduct Sensing admission control procedure, using the content of the Handover Request message that has been received by the AMF or a RAN node.
Transmit to the AMF or a RAN node a Notification Response message on an occurred (or triggered) Handover including one or more of the following:
   Include the list of accepted or not accepted sensing session ID(s),
   cause value in case of failure (i.e., not accepted Session ID)
   and/or (new) sensing resources configuration
Transfer Sensing Context to another SeMF due to UEs mobility

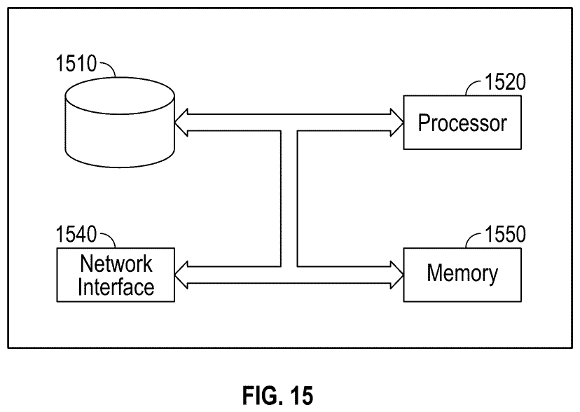

Referring now to FIG. 15, there is shown a block diagram of example components of a UE or a network apparatus. The apparatus includes an electronic storage 1510, a processor 1520, a memory 1550, and a network interface 1540. The various components may be communicatively coupled with each other. The processor 1520 may be and may include any type of processor, such as a single-core central processing unit (CPU), a multi-core CPU, a microprocessor, a digital signal processor (DSP), a System-on-Chip (SoC), or any other type of processor. The memory 1550 may be a volatile type of memory, e.g., RAM, or a non-volatile type of memory, e.g., NAND flash memory. The memory 1550 includes processor-readable instructions that are executable by the processor 1550 to cause the apparatus to perform various operations, including those mentioned herein, such as the operations of FIGS. 3-14C.

The electronic storage 1510 may be and include any type of electronic storage used for storing data, such as hard disk drive, solid state drive, and/or optical disc, among other types of electronic storage. The electronic storage 1510 stores processor-readable instructions for causing the apparatus to perform its operations and stores data associated with such operations, such as storing data relating to 5G NR standards, among other data. The network interface 1540 may implement wireless networking technologies such as 5G NR and/or other wireless networking technologies.

The components shown in FIG. 15 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples.

Example 1.1. An apparatus comprising:
at least one processor; and
at least one memory storing instructions which, when executed by the at least one processor, causes the apparatus at least to perform:
   operating, by a source radio access network (RAN) node serving a user equipment (UE), in a bistatic mode for a sensing service provided by one or more components of a core network; and
   based on a handover decision that switches the UE to a target RAN node, transmitting, by the source RAN node, sensing service information to one of the following:
      the target RAN node, or
      an access and mobility management function (AMF) of the core network,
wherein the sensing service information comprises at least one of the following:
   at least one sensing session identifier corresponding to at least one sensing session for the serving service,
   a sensing resource configuration for the sensing service,
   a sensing session configuration for the sensing service, or
   a sensing data reporting configuration for the sensing service.

Example 1.2. The apparatus of Example 1.1, wherein the instructions when executed by the at least one processor, further causes the apparatus at least to perform:
receiving, by the source RAN node, sensing continuity information comprising at least one of the following:
an indication of whether each of at least one sensing session was accepted or not accepted by a sensing admission control procedure,
an update for the sensing resource configuration,
an update for the sensing session configuration, or
an update for the sensing data reporting configuration.

Example 1.3. The apparatus of Example 1.1 or Example 1.2, wherein the transmitting the sensing service information comprises transmitting the sensing service information in a handover request message.

Example 1.4. The apparatus of Example 1.3, wherein the receiving the sensing continuity information comprises receiving the sensing continuity information in a handover request acknowledgment message from target RAN node.

Example 1.5. The apparatus of Example 1.1 or Example 1.2, wherein the transmitting the sensing service information comprises transmitting the sensing service information in a message indicating that handover is required.

Example 1.6. The apparatus of Example 1.5, wherein the receiving the sensing continuity information comprises receiving the sensing continuity information in a handover command message from the AMF.

Example 1.7. The apparatus of any of the preceding examples, wherein the instructions when executed by the at least one processor, further causes the apparatus at least to perform:
buffering sensed data from operating in the bistatic mode; and
transmitting the sensed data to the target RAN node.

Example 2.1. An apparatus comprising:
means for operating, by a source radio access network (RAN) node serving a user equipment (UE), in a bistatic mode for a sensing service provided by one or more components of a core network; and
based on a handover decision that switches the UE to a target RAN node, means for transmitting, by the source RAN node, sensing service information to one of the following:
   the target RAN node, or
   an access and mobility management function (AMF) of the core network, wherein the sensing service information comprises at least one of the following:
      at least one sensing session identifier corresponding to at least one sensing session for the serving service,
      a sensing resource configuration for the sensing service,
      a sensing session configuration for the sensing service, or
      a sensing data reporting configuration for the sensing service.

Example 2.2. The apparatus of Example 2.1, further comprising:
means for receiving, by the source RAN node, sensing continuity information comprising at least one of the following:
   an indication of whether each of at least one sensing session was accepted or not accepted by a sensing admission control procedure,
   an update for the sensing resource configuration,
   an update for the sensing session configuration, or
   an update for the sensing data reporting configuration.

Example 2.3. The apparatus of Example 2.1 or Example 2.2, wherein the transmitting the sensing service information comprises transmitting the sensing service information in a handover request message.

Example 2.4. The apparatus of Example 2.3, wherein the receiving the sensing continuity information comprises receiving the sensing continuity information in a handover request acknowledgment message from target RAN node.

Example 2.5. The apparatus of Example 2.1 or Example 2.2, wherein the transmitting the sensing service information comprises transmitting the sensing service information in a message indicating that handover is required.

Example 2.6. The apparatus of Example 2.5, wherein the receiving the sensing continuity information comprises receiving the sensing continuity information in a handover command message from the AMF.

Example 2.7. The apparatus of any of the preceding examples, further comprising:
means for buffering sensed data from operating in the bistatic mode; and
means for transmitting the sensed data to the target RAN node.

Example 3.1. A target radio access network (RAN) node comprising:
at least one processor; and
at least one memory storing instructions which, when executed by the at least one processor, causes the target RAN node at least to perform:
   receiving, by a target radio access network (RAN) node of a handover decision, sensing service information for a sensing service, the sensing service provided by one or more components of a core network, the sensing service information comprising at least one of the following:
      at least one sensing session identifier corresponding to at least one sensing session of a source RAN node of the handover decision,
      a sensing resource configuration,
      a sensing session configuration, or
      a sensing data reporting configuration; and operating, by the target RAN node, in a bistatic mode for the sensing service.

Example 3.2. The target radio access network (RAN) node of Example 3.1, wherein the instructions, when executed by the at least one processor, further causes the target RAN node at least to perform:
performing, by the target RAN node, sensing admission control procedure based on the sensing service information.

Example 3.3. The target radio access network (RAN) node of Example 3.2, wherein the instructions, when executed by the at least one processor, further causes the target RAN node at least to perform:
generating, by the target RAN node, based on the sensing admission control procedure, sensing continuity information comprising at least one of the following:
an indication of whether each of the at least one sensing session was accepted or not accepted by the sensing admission control procedure,
an update for the sensing resource configuration,
an update for the sensing session configuration, or
an update for the sensing data reporting configuration; and
transmitting, by the target RAN node, the sensing continuity information.

Example 3.4. The target radio access network (RAN) node of Example 3.3, wherein the receiving the sensing service information comprises receiving, from the source RAN node, the sensing service information in a handover request message, and
wherein the transmitting the sensing continuity information comprises transmitting, to the source RAN node, the sensing continuity information in a handover request acknowledgment message.

Example 3.5. The target radio access network (RAN) node of Example 3.3, wherein the receiving the sensing service information comprises receiving, from an access and mobility management function (AMF) of the core network, the sensing service information in a handover request message, and
wherein the transmitting the sensing continuity information comprises transmitting, to the AMF, the sensing continuity information in a handover request acknowledgment message.

Example 3.6. The target radio access network (RAN) node of Example 3.5, wherein the AMF is a target AMF in case of an AMF relocation due to handover.

Example 3.7. The target radio access network (RAN) node of Example 3.3, wherein the instructions, when executed by the at least one processor, further causes the target RAN node at least to perform:
transmitting, by the target RAN node, to an access and mobility management function (AMF) of the core network, a path switch request message comprising the sensing continuity information.

Example 3.8. The target radio access network (RAN) node of Example 3.1, wherein the instructions, when executed by the at least one processor, further causes the target RAN node at least to perform:
transmitting, by the target RAN node, to an access and mobility management function (AMF) of the core network, a path switch request message comprising the sensing service information; and
receiving, by the target RAN node, from the AMF, a path switch request acknowledgment message comprising the sensing continuity information, the sensing continuity information comprising at least one of the following:
   an indication of whether each of at least one sensing session was accepted or not accepted by a sensing admission control procedure,
   an update for the sensing resource configuration,
   an update for the sensing session configuration, or
   an update for the sensing data reporting configuration.

Example 3.9. The target radio access network (RAN) node of Example 3.1, wherein the instructions, when executed by the at least one processor, further causes the target RAN node at least to perform:
receiving, by the target RAN node, from a sensing management function (SeMF) of the one or more components of the core network, a sensing admission control procedure request acknowledgment message comprising the sensing continuity information, the sensing continuity information comprising at least one of the following:
   an indication of whether each of at least one sensing session was accepted or not accepted by a sensing admission control procedure,
   an update for the sensing resource configuration,
   an update for the sensing session configuration, or
   an update for the sensing data reporting configuration.

Example 3.10. The target radio access network (RAN) node of Example 3.9, wherein the instructions, when executed by the at least one processor, further causes the target RAN node at least to perform:
transmitting, by the target RAN node, to an access and mobility management function (AMF) of the core network, a handover execution notification message comprising the sensing service information.

Example 3.11. The target radio access network (RAN) node of Example 3.1, wherein the instructions, when executed by the at least one processor, further causes the target RAN node at least to perform:
receiving, by the target RAN node, from a sensing management function (SeMF) of the one or more components of the core network, a sensing session update request message comprising the sensing continuity information, the sensing continuity information comprising an indication of whether each of at least one sensing session was accepted or not accepted by a sensing admission control procedure;
transmitting, by the target RAN node, to a user equipment (UE) served by the target RAN node, a reconfiguration of UE sensing configuration message;
receiving, by the target RAN node, from the UE, a response to the reconfiguration of UE sensing configuration message; and
transmitting, by the target RAN node, to the SeMF, a response to the sensing session update request message.

Example 3.12. The target radio access network (RAN) node of any of the preceding examples, further comprising:
receiving, from the source RAN node, sensed data buffered by the source RAN node.

Example 4.1. A target radio access network (RAN) node comprising:
means for receiving, by a target radio access network (RAN) node of a handover decision, sensing service information for a sensing service, the sensing service provided by one or more components of a core network, the sensing service information comprising at least one of the following:
   at least one sensing session identifier corresponding to at least one sensing session of a source RAN node of the handover decision,
   a sensing resource configuration,
   a sensing session configuration, or
   a sensing data reporting configuration; and means for operating, by the target RAN node, in a bistatic mode for the sensing service.

Example 4.2. The target radio access network (RAN) node of Example 4.1, further comprising:
means for performing, by the target RAN node, sensing admission control procedure based on the sensing service information.

Example 4.3. The target radio access network (RAN) node of Example 4.2, further comprising:
means for generating, by the target RAN node, based on the sensing admission control procedure, sensing continuity information comprising at least one of the following:
   an indication of whether each of the at least one sensing session was accepted or not accepted by the sensing admission control procedure,
   an update for the sensing resource configuration,
   an update for the sensing session configuration, or
   an update for the sensing data reporting configuration; and means for transmitting, by the target RAN node, the sensing continuity information.

Example 4.4. The target radio access network (RAN) node of Example 4.3, wherein the receiving the sensing service information comprises receiving, from the source RAN node, the sensing service information in a handover request message, and
wherein the transmitting the sensing continuity information comprises transmitting, to the source RAN node, the sensing continuity information in a handover request acknowledgment message.

Example 4.5. The target radio access network (RAN) node of Example 4.3, wherein the receiving the sensing service information comprises receiving, from an access and mobility management function (AMF) of the core network, the sensing service information in a handover request message, and
wherein the transmitting the sensing continuity information comprises transmitting, to the AMF, the sensing continuity information in a handover request acknowledgment message.

Example 4.6. The target radio access network (RAN) node of Example 4.5, wherein the AMF is a target AMF in case of an AMF relocation due to handover.

Example 4.7. The target radio access network (RAN) node of Example 4.3, further comprising:
means for transmitting, by the target RAN node, to an access and mobility management function (AMF) of the core network, a path switch request message comprising the sensing continuity information.

Example 4.8. The target radio access network (RAN) node of Example 4.1, further comprising:
means for transmitting, by the target RAN node, to an access and mobility management function (AMF) of the core network, a path switch request message comprising the sensing service information; and
means for receiving, by the target RAN node, from the AMF, a path switch request acknowledgment message comprising the sensing continuity information, the sensing continuity information comprising at least one of the following:
   an indication of whether each of at least one sensing session was accepted or not accepted by a sensing admission control procedure,
   an update for the sensing resource configuration,
   an update for the sensing session configuration, or
   an update for the sensing data reporting configuration.

Example 4.9. The target radio access network (RAN) node of Example 4.1, further comprising:
means for receiving, by the target RAN node, from a sensing management function (SeMF) of the one or more components of the core network, a sensing admission control procedure request acknowledgment message comprising the sensing continuity information, the sensing continuity information comprising at least one of the following:
   an indication of whether each of at least one sensing session was accepted or not accepted by a sensing admission control procedure,
   an update for the sensing resource configuration,
   an update for the sensing session configuration, or
   an update for the sensing data reporting configuration.

Example 4.10. The target radio access network (RAN) node of Example 4.9, further comprising:
means for transmitting, by the target RAN node, to an access and mobility management function (AMF) of the core network, a handover execution notification message comprising the sensing service information.

Example 4.11. The target radio access network (RAN) node of Example 4.1, further comprising:
means for receiving, by the target RAN node, from a sensing management function (SeMF) of the one or more components of the core network, a sensing session update request message comprising the sensing continuity information, the sensing continuity information comprising an indication of whether each of at least one sensing session was accepted or not accepted by a sensing admission control procedure;
means for transmitting, by the target RAN node, to a user equipment (UE) served by the target RAN node, a reconfiguration of UE sensing configuration message;
means for receiving, by the target RAN node, from the UE, a response to the reconfiguration of UE sensing configuration message; and
means for transmitting, by the target RAN node, to the SeMF, a response to the sensing session update request message.

Example 4.12. The target radio access network (RAN) node of any of the preceding examples, further comprising:
means for receiving, from the source RAN node, sensed data buffered by the source RAN node.

Example 5.1. An apparatus comprising:
at least one processor; and
at least one memory storing instructions which, when executed by the at least one processor, causes the apparatus at least to perform:
   receiving, by an access and mobility management function (AMF) of a core network, a first message relating to a handover decision for a handover from a source radio access network (RAN) node to the target RAN node, wherein the source RAN node is utilized by a sensing service provided by a sensing management function (SeMF) of the core network; and
   transmitting, by the AMF, to the SeMF, a notification message indicating that the handover has occurred.

Example 5.2. The apparatus of Example 5.1, wherein the first message comprises sensing service information of the sensing service, the sensing service information comprising at least one of the following:
at least one sensing session identifier corresponding to at least one sensing session of the source RAN node,
a sensing resource configuration,
a sensing session configuration, or
a sensing data reporting configuration.

Example 5.3. The apparatus of Example 5.2, wherein the first message is a path switch request message from the target RAN node,
the apparatus further comprising:
   receiving, by the AMF, from the SeMF, an acknowledgement of the notification message indicating that the handover has occurred; and
   transmitting, by the AMF, to the target RAN node, an acknowledgement of the path switch request message,
wherein the acknowledgement of the notification message and the acknowledgement of the path switch request message comprise sensing continuity information, the sensing continuity information comprising at least one of the following:
   an indication of whether each of the at least one sensing session, of the source RAN node, was accepted or not accepted by a sensing admission control procedure in connection with the handover decision,
   an update for the sensing resource configuration,
   an update for the sensing session configuration or
   an update for the sensing data reporting configuration.

Example 5.4. The apparatus of Example 5.2, wherein the first message is a message, from the source RAN node, indicating that handover is required.

Example 5.5. The apparatus of Example 5.4, wherein the instructions, when executed by the at least one processor, further causes the apparatus at least to perform: transmitting, by the AMF, to the target RAN node, a handover request message comprising the sensing service information.

Example 5.6. The apparatus of Example 5.5, wherein the instructions, when executed by the at least one processor, further causes the apparatus at least to perform:
receiving, by the AMF, from the target RAN node, a handover request acknowledgment message comprising the sensing continuity information, the sensing continuity information comprising at least one of the following:
   an indication of whether each of the at least one sensing session, of the source RAN node, was accepted or not accepted by a sensing admission control procedure in connection with the handover decision,
   an update for a sensing resource configuration of the sensing service,
   an update for a sensing session configuration of the sensing service, or
   an update for a sensing data reporting configuration of the sensing service; and
transmitting, by the AMF, to the source RAN node, a handover command message comprising the sensing continuity information.

Example 5.7. The apparatus of Example 5.1, wherein the first message comprises sensing continuity information of the sensing service, the sensing continuity information comprising at least one of the following:
an indication of whether each of at least one sensing session, of the source RAN node, was accepted or not accepted by a sensing admission control procedure in connection with the handover decision,
an update for a sensing resource configuration of the sensing service,
an update for a sensing session configuration of the sensing service, or
an update for a sensing data reporting configuration of the sensing service.

Example 5.8. The apparatus of Example 5.1, wherein the notification message indicating that the handover has occurred comprises at least one of the following:
an indication of whether each of at least one sensing session, of the source RAN node, was accepted or not accepted by a sensing admission control procedure in connection with the handover,
an update for a sensing resource configuration of the sensing service,
an update for a sensing session configuration of the sensing service, or
an update for a sensing data reporting configuration of the sensing service.

Example 5.9. The apparatus of Example 5.1, wherein the notification message indicating that the handover has occurred comprises at least one sensing session identifier corresponding to at least one sensing session of the source RAN node.

Example 5.10. The apparatus of Example 5.1, wherein the instructions, when executed by the at least one processor, further causes the apparatus at least to perform:
receiving, by the AMF, from the SeMF, a sensing session update request message comprising sensing continuity information;
transmitting, by the AMF, to the target RAN node, the sensing session update request message comprising the sensing continuity information;
receiving, by the AMF, from the target RAN node, a response to the sensing session update request message; and
transmitting, by the AMF, to the SeMF, the response to the sensing session update request message,
wherein the sensing continuity information comprises at least one of the following:
   an indication of whether each of at least one sensing session, of the source RAN node, was accepted or not accepted by a sensing admission control procedure in connection with the handover,
   an update for a sensing resource configuration of the sensing service,
   an update for a sensing session configuration of the sensing service, or
   an update for a sensing data reporting configuration of the sensing service.

Example 5.12. An apparatus comprising:
at least one processor; and
at least one memory storing instructions which, when executed by the at least one processor, causes the apparatus at least to perform:
   receiving, by a source access and mobility management function (AMF) of a core network, a first message relating to a handover decision for a handover from a source radio access network (RAN) node to the target RAN node, wherein the source RAN node is utilized by a sensing service provided by a sensing management function (SeMF) of the core network; and
   transmitting, by the source AMF, to a target AMF, a create user equipment (UE) context request message,
wherein the first message and the create UE context request message comprise sensing service information of the sensing service, the sensing service information comprising at least one of the following:
   at least one sensing session identifier corresponding to at least one sensing session of the source RAN node,
   a sensing resource configuration,
   a sensing session configuration, or
   a sensing data reporting configuration.

Example 5.13. The apparatus of claim 12, wherein the first message is a message, from the source RAN node, indicating that handover is required.

Example 5.14. The apparatus of claim 12 or claim 13, wherein the instructions, when executed by the at least one processor, further causes the apparatus at least to perform:
receiving, by the source AMF, from the target AMF, a response to the create UE context request message; and
transmitting, by the source AMF, to the source RAN node, a handover command message,
wherein the response to the create UE context request message and the handover command message comprise at least one of the following:
   an indication of whether each of the at least one sensing session, of the source RAN node, was accepted or not accepted by a sensing admission control procedure in connection with the handover decision,
   an update for the sensing resource configuration,
   an update for the sensing session configuration or
   an update for the sensing data reporting configuration.

Example 5.16. An apparatus comprising:
at least one processor; and
at least one memory storing instructions which, when executed by the at least one processor, causes the apparatus at least to perform:
   receiving, by a target access and mobility management function (AMF) of a core network, from a source AMF, a first message relating to a handover decision for a handover from a source radio access network (RAN) node to the target RAN node, wherein the source RAN node is utilized by a sensing service provided by a sensing management function (SeMF) of the core network; and
   transmitting, by the target AMF, to the target RAN node, a handover request message,
wherein the first message and the handover request message comprise sensing service information of the sensing service, the sensing service information comprising at least one of the following:
   at least one sensing session identifier corresponding to at least one sensing session of the source RAN node,
   a sensing resource configuration,
   a sensing session configuration, or
   a sensing data reporting configuration.

Example 5.17. The apparatus of Example 5.16, wherein the first message is a create user equipment (UE) context request message from the source AMF.

Example 5.18. The apparatus of claim 16 or Example 5.17, wherein the instructions, when executed by the at least one processor, further causes the apparatus at least to perform:
receiving, by the target AMF, from the target RAN node, a handover request acknowledgment message; and
transmitting, by the target AMF, to the source AMF, a response to the create UE context request message,
wherein the handover request acknowledgment message and the response to the create UE context request message comprise sensing continuity information, the sensing continuity information comprising at least one of the following:
   an indication of whether each of the at least one sensing session, of the source RAN node, was accepted or not accepted by a sensing admission control procedure in connection with the handover decision,
   an update for the sensing resource configuration,
   an update for the sensing session configuration or
   an update for the sensing data reporting configuration.

Example 5.19. The apparatus of Example 5.16 or Example 5.17, wherein the instructions, when executed by the at least one processor, further causes the apparatus at least to perform:
transmitting, by the target AMF, to the SeMF, a notification message indicating that the handover has occurred.

Example 5.20. The apparatus of Example 5.19, wherein the notification message comprises sensing continuity information, the sensing continuity information comprising an indication of whether each of the at least one sensing session, of the source RAN node, was accepted or not accepted by a sensing admission control procedure in connection with the handover decision,
an update for the sensing resource configuration,
an update for the sensing session configuration or
an update for the sensing data reporting configuration.

Example 5.21. The apparatus of Example 5.19, wherein the notification message comprises the at least one sensing session identifier corresponding to the at least one sensing session of the source RAN node.

Example 5.23. An apparatus comprising:
at least one processor; and
at least one memory storing instructions which, when executed by the at least one processor, causes the apparatus at least to perform:
receiving, by an access and mobility management function (AMF) of a core network, a first message indicating that a handover, from a source radio access network (RAN) node to a target RAN node, has occurred, wherein the source RAN node is utilized by a sensing service provided by a source sensing management function (SeMF) of the core network;
determining, by the AMF, that the source SeMF is to be changed to a target SeMF; and
transmitting, by the AMF, to the source SeMF, a second message indicating that the handover has occurred and that the source SeMF is to be changed to the target SeMF.

Example 5.24. The apparatus of Example 5.23, wherein the instructions, when executed by the at least one processor, further causes the apparatus at least to perform:
receiving, by the AMF, from the target SeMF, an acknowledgment of the second message.

Example 5.24. The apparatus of Example 5.23, wherein the instructions, when executed by the at least one processor, further causes the apparatus at least to perform:
receiving, by the AMF, from the target SeMF, an acknowledgment of the second message.

Example 5.1.1. A method comprising:
receiving, by an access and mobility management function (AMF) of a core network, a first message relating to a handover decision for a handover from a source radio access network (RAN) node to the target RAN node, wherein the source RAN node is utilized by a sensing service provided by a sensing management function (SeMF) of the core network; and
transmitting, by the AMF, to the SeMF, a notification message indicating that the handover has occurred.

Example 5.1.2. The method of Example 5.1.1, wherein the first message comprises sensing service information of the sensing service, the sensing service information comprising at least one of the following:
at least one sensing session identifier corresponding to at least one sensing session of the source RAN node,
a sensing resource configuration,
a sensing session configuration, or
a sensing data reporting configuration.

Example 5.1.3. The method of Example 5.1.2, wherein the first message is a path switch request message from the target RAN node,
the method further comprising:
receiving, by the AMF, from the SeMF, an acknowledgement of the notification message indicating that the handover has occurred; and
transmitting, by the AMF, to the target RAN node, an acknowledgement of the path switch request message,
wherein the acknowledgement of the notification message and the acknowledgement of the path switch request message comprise sensing continuity information, the sensing continuity information comprising at least one of the following:
an indication of whether each of the at least one sensing session, of the source RAN node, was accepted or not accepted by a sensing admission control procedure in connection with the handover decision,
an update for the sensing resource configuration,
an update for the sensing session configuration or
an update for the sensing data reporting configuration.

Example 5.1.4. The method of Example 5.1.2, wherein the first message is a message, from the source RAN node, indicating that handover is required.

Example 5.1.5. The method of Example 5.1.4, further comprising:
transmitting, by the AMF, to the target RAN node, a handover request message comprising the sensing service information.

Example 5.1.6. The method of Example 5.1.5, further comprising:
receiving, by the AMF, from the target RAN node, a handover request acknowledgment message comprising the sensing continuity information, the sensing continuity information comprising at least one of the following:
   an indication of whether each of the at least one sensing session, of the source RAN node, was accepted or not accepted by a sensing admission control procedure in connection with the handover decision,
   an update for a sensing resource configuration of the sensing service,
   an update for a sensing session configuration of the sensing service, or
   an update for a sensing data reporting configuration of the sensing service; and
   transmitting, by the AMF, to the source RAN node, a handover command message comprising the sensing continuity information.

Example 5.1.7. The method of Example 5.1.1, wherein the first message comprises sensing continuity information of the sensing service, the sensing continuity information comprising at least one of the following:
an indication of whether each of at least one sensing session, of the source RAN node, was accepted or not accepted by a sensing admission control procedure in connection with the handover decision,
an update for a sensing resource configuration of the sensing service,
an update for a sensing session configuration of the sensing service, or
an update for a sensing data reporting configuration of the sensing service.

Example 5.1.8. The method of Example 5.1.1, wherein the notification message indicating that the handover has occurred comprises at least one of the following:
an indication of whether each of at least one sensing session, of the source RAN node, was accepted or not accepted by a sensing admission control procedure in connection with the handover,
an update for a sensing resource configuration of the sensing service,
an update for a sensing session configuration of the sensing service, or
an update for a sensing data reporting configuration of the sensing service.

Example 5.1.9. The method of Example 5.1.1, wherein the notification message indicating that the handover has occurred comprises at least one sensing session identifier corresponding to at least one sensing session of the source RAN node.

Example 5.1.10. The method of Example 5.1.1, further comprising:
receiving, by the AMF, from the SeMF, a sensing session update request message comprising sensing continuity information;
transmitting, by the AMF, to the target RAN node, the sensing session update request message comprising the sensing continuity information;
receiving, by the AMF, from the target RAN node, a response to the sensing session update request message; and
transmitting, by the AMF, to the SeMF, the response to the sensing session update request message,
wherein the sensing continuity information comprises at least one of the following:
   an indication of whether each of at least one sensing session, of the source RAN node, was accepted or not accepted by a sensing admission control procedure in connection with the handover,
   an update for a sensing resource configuration of the sensing service,
   an update for a sensing session configuration of the sensing service, or
   an update for a sensing data reporting configuration of the sensing service.

Example 5.1.12. A method comprising:
receiving, by a source access and mobility management function (AMF) of a core network, a first message relating to a handover decision for a handover from a source radio access network (RAN) node to the target RAN node, wherein the source RAN node is utilized by a sensing service provided by a sensing management function (SeMF) of the core network; and
transmitting, by the source AMF, to a target AMF, a create user equipment (UE) context request message,
wherein the first message and the create UE context request message comprise sensing service information of the sensing service, the sensing service information comprising at least one of the following:
   at least one sensing session identifier corresponding to at least one sensing session of the source RAN node,
   a sensing resource configuration,
   a sensing session configuration, or
   a sensing data reporting configuration.

Example 5.1.13. The method of Example 5.1.12, wherein the first message is a message, from the source RAN node, indicating that handover is required.

Example 5.1.14. The method of Example 5.1.12 or Example 5.1.13, further comprising:
receiving, by the source AMF, from the target AMF, a response to the create UE context request message; and
transmitting, by the source AMF, to the source RAN node, a handover command message,
wherein the response to the create UE context request message and the handover command message comprise at least one of the following:
   an indication of whether each of the at least one sensing session, of the source RAN node, was accepted or not accepted by a sensing admission control procedure in connection with the handover decision,
   an update for the sensing resource configuration,
   an update for the sensing session configuration or
   an update for the sensing data reporting configuration.

Example 5.1.16. A method comprising:
receiving, by a target access and mobility management function (AMF) of a core network, from a source AMF, a first message relating to a handover decision for a handover from a source radio access network (RAN) node to the target RAN node, wherein the source RAN node is utilized by a sensing service provided by a sensing management function (SeMF) of the core network; and
transmitting, by the target AMF, to the target RAN node, a handover request message,
wherein the first message and the handover request message comprise sensing service information of the sensing service, the sensing service information comprising at least one of the following:
   at least one sensing session identifier corresponding to at least one sensing session of the source RAN node,
   a sensing resource configuration,
   a sensing session configuration, or
   a sensing data reporting configuration.

Example 5.1.17. The method of Example 5.1.16, wherein the first message is a create user equipment (UE) context request message from the source AMF.

Example 5.1.18. The method of Example 5.1.16 or Example 5.1.17, further comprising:
receiving, by the target AMF, from the target RAN node, a handover request acknowledgment message; and
transmitting, by the target AMF, to the source AMF, a response to the create UE context request message,
wherein the handover request acknowledgment message and the response to the create UE context request message comprise sensing continuity information, the sensing continuity information comprising at least one of the following:
   an indication of whether each of the at least one sensing session, of the source RAN node, was accepted or not accepted by a sensing admission control procedure in connection with the handover decision,
   an update for the sensing resource configuration,
   an update for the sensing session configuration or
   an update for the sensing data reporting configuration.

Example 5.1.19. The method of Example 5.1.16 or Example 5.1.17, further comprising:

transmitting, by the target AMF, to the SeMF, a notification message indicating that the handover has occurred.

Example 5.1.20. The method of Example 5.1.19, wherein the notification message comprises sensing continuity information, the sensing continuity information comprising an indication of whether each of the at least one sensing session, of the source RAN node, was accepted or not accepted by a sensing admission control procedure in connection with the handover decision.

Example 5.1.21. The method of Example 5.1.19, wherein the notification message comprises the at least one sensing session identifier corresponding to the at least one sensing session of the source RAN node.

Example 5.1.23. A method comprising:
receiving, by an access and mobility management function (AMF) of a core network, a first message indicating that a handover, from a source radio access network (RAN) node to a target RAN node, has occurred, wherein the source RAN node is utilized by a sensing service provided by a source sensing management function (SeMF) of the core network;
determining, by the AMF, that the source SeMF is to be changed to a target SeMF; and
transmitting, by the AMF, to the source SeMF, a second message indicating that the handover has occurred and that the source SeMF is to be changed to the target SeMF.

Example 5.1.24. The method of Example 5.1.23, further comprising:
receiving, by the AMF, from the target SeMF, an acknowledgment of the second message.

Example 6.1. An apparatus comprising:
means for receiving, by an access and mobility management function (AMF) of a core network, a first message relating to a handover decision for a handover from a source radio access network (RAN) node to the target RAN node, wherein the source RAN node is utilized by a sensing service provided by a sensing management function (SeMF) of the core network; and
means for transmitting, by the AMF, to the SeMF, a notification message indicating that the handover has occurred.

Example 6.2. The apparatus of Example 6.1, wherein the first message comprises sensing service information of the sensing service, the sensing service information comprising at least one of the following:
at least one sensing session identifier corresponding to at least one sensing session of the source RAN node,
a sensing resource configuration,
a sensing session configuration, or
a sensing data reporting configuration.

Example 6.3. The apparatus of Example 6.2, wherein the first message is a path switch request message from the target RAN node,
the apparatus further comprising:
   means for receiving, by the AMF, from the SeMF, an acknowledgement of the notification message indicating that the handover has occurred; and
   means for transmitting, by the AMF, to the target RAN node, an acknowledgement of the path switch request message,
wherein the acknowledgement of the notification message and the acknowledgement of the path switch request message comprise sensing continuity information, the sensing continuity information comprising at least one of the following:
   an indication of whether each of the at least one sensing session, of the source RAN node, was accepted or not accepted by a sensing admission control procedure in connection with the handover decision,
   an update for the sensing resource configuration,
   an update for the sensing session configuration or
   an update for the sensing data reporting configuration.

Example 6.4. The apparatus of Example 6.2, wherein the first message is a message, from the source RAN node, indicating that handover is required.

Example 6.5. The apparatus of Example 6.4, further comprising:
means for transmitting, by the AMF, to the target RAN node, a handover request message comprising the sensing service information.

Example 6.6. The apparatus of Example 6.5, further comprising:
means for receiving, by the AMF, from the target RAN node, a handover request acknowledgment message comprising the sensing continuity information, the sensing continuity information comprising at least one of the following:
   an indication of whether each of the at least one sensing session, of the source RAN node, was accepted or not accepted by a sensing admission control procedure in connection with the handover decision,
   an update for a sensing resource configuration of the sensing service,
   an update for a sensing session configuration of the sensing service, or
   an update for a sensing data reporting configuration of the sensing service; and means for transmitting, by the AMF, to the source RAN node, a handover command message comprising the sensing continuity information.

Example 6.7 The apparatus of Example 6.1, wherein the first message comprises sensing continuity information of the sensing service, the sensing continuity information comprising at least one of the following:
an indication of whether each of at least one sensing session, of the source RAN node, was accepted or not accepted by a sensing admission control procedure in connection with the handover decision,
an update for a sensing resource configuration of the sensing service,
an update for a sensing session configuration of the sensing service, or
an update for a sensing data reporting configuration of the sensing service.

Example 6.8. The apparatus of Example 6.1, wherein the notification message indicating that the handover has occurred comprises at least one of the following:
an indication of whether each of at least one sensing session, of the source RAN node, was accepted or not accepted by a sensing admission control procedure in connection with the handover,
an update for a sensing resource configuration of the sensing service,
an update for a sensing session configuration of the sensing service, or
an update for a sensing data reporting configuration of the sensing service.

Example 6.9. The apparatus of Example 6.1, wherein the notification message indicating that the handover has occurred comprises at least one sensing session identifier corresponding to at least one sensing session of the source RAN node.

Example 6.10. The apparatus of Example 6.1, further comprising:
means for receiving, by the AMF, from the SeMF, a sensing session update request message comprising sensing continuity information;
means for transmitting, by the AMF, to the target RAN node, the sensing session update request message comprising the sensing continuity information;
means for receiving, by the AMF, from the target RAN node, a response to the sensing session update request message; and
means for transmitting, by the AMF, to the SeMF, the response to the sensing session update request message,
wherein the sensing continuity information comprises at least one of the following:
   an indication of whether each of at least one sensing session, of the source RAN node, was accepted or not accepted by a sensing admission control procedure in connection with the handover,
   an update for a sensing resource configuration of the sensing service,
   an update for a sensing session configuration of the sensing service, or
   an update for a sensing data reporting configuration of the sensing service.

Example 6.12. An apparatus comprising:
means for receiving, by a source access and mobility management function (AMF) of a core network, a first message relating to a handover decision for a handover from a source radio access network (RAN) node to the target RAN node, wherein the source RAN node is utilized by a sensing service provided by a sensing management function (SeMF) of the core network; and
means for transmitting, by the source AMF, to a target AMF, a create user equipment (UE) context request message,
wherein the first message and the create UE context request message comprise sensing service information of the sensing service, the sensing service information comprising at least one of the following:
   at least one sensing session identifier corresponding to at least one sensing session of the source RAN node,
   a sensing resource configuration,
   a sensing session configuration, or
   a sensing data reporting configuration.

Example 6.13. The apparatus of Example 6.12, wherein the first message is a message, from the source RAN node, indicating that handover is required.

Example 6.14. The apparatus of Example 6.12 or Example 6.13, further comprising:
means for receiving, by the source AMF, from the target AMF, a response to the create UE context request message; and
means for transmitting, by the source AMF, to the source RAN node, a handover command message,
wherein the response to the create UE context request message and the handover command message comprise at least one of the following:
   an indication of whether each of the at least one sensing session, of the source RAN node, was accepted or not accepted by a sensing admission control procedure in connection with the handover decision,
   an update for the sensing resource configuration,
   an update for the sensing session configuration or
   an update for the sensing data reporting configuration.

Example 6.16. An apparatus comprising:
means for receiving, by a target access and mobility management function (AMF) of a core network, from a source AMF, a first message relating to a handover decision for a handover from a source radio access network (RAN) node to the target RAN node, wherein the source RAN node is utilized by a sensing service provided by a sensing management function (SeMF) of the core network; and
means for transmitting, by the target AMF, to the target RAN node, a handover request message,
wherein the first message and the handover request message comprise sensing service information of the sensing service, the sensing service information comprising at least one of the following:
   at least one sensing session identifier corresponding to at least one sensing session of the source RAN node,
   a sensing resource configuration,
   a sensing session configuration, or
   a sensing data reporting configuration.

Example 6.17. The apparatus of Example 6.16, wherein the first message is a create user equipment (UE) context request message from the source AMF.

Example 6.18. The apparatus of Example 6.16 or Example 6.17, further comprising:
means for receiving, by the target AMF, from the target RAN node, a handover request acknowledgment message; and
means for transmitting, by the target AMF, to the source AMF, a response to the create UE context request message,
wherein the handover request acknowledgment message and the response to the create UE context request message comprise sensing continuity information, the sensing continuity information comprising at least one of the following:
   an indication of whether each of the at least one sensing session, of the source RAN node, was accepted or not accepted by a sensing admission control procedure in connection with the handover decision,
   an update for the sensing resource configuration,
   an update for the sensing session configuration or
   an update for the sensing data reporting configuration.

Example 6.19. The apparatus of Example 6.16 or Example 6.17, further comprising:
means for transmitting, by the target AMF, to the SeMF, a notification message indicating that the handover has occurred.

Example 6.20. The apparatus of Example 6.19, wherein the notification message comprises sensing continuity information, the sensing continuity information comprising an indication of whether each of the at least one sensing session, of the source RAN node, was accepted or not accepted by a sensing admission control procedure in connection with the handover decision,
an update for the sensing resource configuration,
an update for the sensing session configuration or
an update for the sensing data reporting configuration.

Example 6.21. The apparatus of Example 6.19, wherein the notification message comprises the at least one sensing session identifier corresponding to the at least one sensing session of the source RAN node.

Example 6.23. An apparatus comprising:
means for receiving, by an access and mobility management function (AMF) of a core network, a first message indicating that a handover, from a source radio access network (RAN) node to a target RAN node, has occurred, wherein the source RAN node is utilized by a sensing service provided by a source sensing management function (SeMF) of the core network;
means for determining, by the AMF, that the source SeMF is to be changed to a target SeMF; and
means for transmitting, by the AMF, to the source SeMF, a second message indicating that the handover has occurred and that the source SeMF is to be changed to the target SeMF.

Example 6.24. The apparatus of claim 23, further comprising:
means for receiving, by the AMF, from the target SeMF, an acknowledgment of the second message.

Example 7.1. An apparatus comprising:
at least one processor; and
at least one memory storing instructions which, when executed by the at least one processor, causes the apparatus at least to perform:
   providing, by a sensing management function (SeMF) of a core network, a sensing service, the sensing service comprising sensing service information of a source radio access network (RAN) node of a handover decision, the sensing service information comprising at least one of the following:
      at least one sensing session identifier corresponding to at least one sensing session at the source RAN node,
      a sensing resource configuration,
      a sensing session configuration, or
      a sensing data reporting configuration; and
   receiving, by the SeMF, from an access and mobility management function (AMF) of the core network, a notification message indicating that a handover for the handover decision has occurred.

Example 7.2. The apparatus of Example 7.1, wherein the notification message comprises sensing continuity information comprising at least one of the following:
an indication of whether each of at least one sensing session was accepted or not accepted by a sensing admission control procedure,
an update for the sensing resource configuration,
an update for the sensing session configuration, or
an update for the sensing data reporting configuration.

Example 7.3. The apparatus of Example 7.1, wherein the notification message comprises the at least one sensing session identifier corresponding to the at least one sensing session at the source RAN node.

Example 7.4. The apparatus of Example 7.1, wherein the instructions, when executed by the at least one processor, further causes the apparatus at least to perform:
based on the notification message indicating that the handover for the handover decision has occurred, performing, by the SeMF, sensing admission control procedure.

Example 7.5. The apparatus of Example 7.4, further comprising:
generating, by the SeMF, based on the sensing admission control procedure, sensing continuity information comprising at least one of the following:
   an indication of whether each of at least one sensing session was accepted or not accepted by the sensing admission control procedure,
   an update for the sensing resource configuration,
   an update for the sensing session configuration, or
   an update for the sensing data reporting configuration.

Example 7.6. The apparatus of Example 7.5, wherein the instructions, when executed by the at least one processor, further causes the apparatus at least to perform:
transmitting, by the SeMF, to the AMF, an acknowledgment of the notification message, the acknowledgment comprising the sensing continuity information.

Example 7.7. The apparatus of Example 7.5, wherein the instructions, when executed by the at least one processor, further causes the apparatus at least to perform:
transmitting, by the SeMF, to a target RAN node of the handover, a sensing admission control procedure request acknowledgment message comprising the sensing continuity information.

Example 7.8. The apparatus of Example 7.5, wherein the instructions, when executed by the at least one processor, further causes the apparatus at least to perform:
transmitting, by the SeMF, to a target RAN node of the handover, a sensing session update request message comprising the sensing continuity information; and
receiving, by the SeMF, from the target RAN node, a response to the sensing session update request message.

Example 7.9. The apparatus of Example 7.1, wherein the notification message further comprises an indication to change SeMF to a target SeMF.

Example 7.10. The apparatus of Example 7.1, wherein the instructions, when executed by the at least one processor, further causes the apparatus at least to perform:
determining, by the SeMF, to change SeMF to a target SeMF.

Example 7.11. The apparatus of Example 7.9 or Example 7.10, wherein the instructions, when executed by the at least one processor, further causes the apparatus at least to perform:
transmitting, by the SeMF, to the target SeMF, a sensing context transfer request message; and
receiving, by the SeMF, from the target SeMF, a response to the sensing context transfer request message.

Example 7.13. An apparatus comprising:
at least one processor; and
at least one memory storing instructions which, when executed by the at least one processor, causes the apparatus at least to perform:
   receiving, by a target sensing management function (SeMF) of a core network, from a source SeMF, a sensing context transfer request message relating to a sensing service provided by the SeMF to at least one network function of the following:
      an application function, or
      a network exposure function; and
   transmitting, by the target SeMF, to the at least one network function, a second message indicating that target SeMF is the new provider of the sensing service.

Example 7.14. The apparatus of Example 7.13, wherein the instructions, when executed by the at least one processor, further causes the apparatus at least to perform:
receiving, by the target SeMF, from the at least one network function, an acknowledgement of the second message; and
transmitting, by the target SeMF, to the source SeMF, a response to the sensing context transfer request message.

Example 7.15. The apparatus of Example 7.14, wherein the instructions, when executed by the at least one processor, further causes the apparatus at least to perform:
transmitting, by the target SeMF, to an access and mobility management function (AMF), an acknowledgment of a handover notification message that was transmitted by the AMF to the source SeMF.

Example 7.1.1. A method comprising:
providing, by a sensing management function (SeMF) of a core network, a sensing service, the sensing service comprising sensing service information of a source radio access network (RAN) node of a handover decision, the sensing service information comprising at least one of the following:
   at least one sensing session identifier corresponding to at least one sensing session at the source RAN node,
   a sensing resource configuration,
   a sensing session configuration, or
   a sensing data reporting configuration; and
receiving, by the SeMF, from an access and mobility management function (AMF) of the core network, a notification message indicating that a handover for the handover decision has occurred.

Example 7.1.2. The method of Example 7.1.1, wherein the notification message comprises sensing continuity information comprising at least one of the following:
an indication of whether each of at least one sensing session was accepted or not accepted by a sensing admission control procedure,
an update for the sensing resource configuration,
an update for the sensing session configuration, or
an update for the sensing data reporting configuration.

Example 7.1.3. The method of Example 7.1.1, wherein the notification message comprises the at least one sensing session identifier corresponding to the at least one sensing session at the source RAN node.

Example 7.1.4. The method of Example 7.1.1, further comprising:
based on the notification message indicating that the handover for the handover decision has occurred, performing, by the SeMF, sensing admission control procedure.

Example 7.1.5. The method of Example 7.1.4, further comprising:
generating, by the SeMF, based on the sensing admission control procedure, sensing continuity information comprising at least one of the following:
   an indication of whether each of at least one sensing session was accepted or not accepted by the sensing admission control procedure,
   an update for the sensing resource configuration,
   an update for the sensing session configuration, or
   an update for the sensing data reporting configuration.

Example 7.1.6. The method of Example 7.1.5, further comprising:
transmitting, by the SeMF, to the AMF, an acknowledgment of the notification message, the acknowledgment comprising the sensing continuity information.

Example 7.1.7. The method of Example 7.1.5, further comprising:
transmitting, by the SeMF, to a target RAN node of the handover, a sensing admission control procedure request acknowledgment message comprising the sensing continuity information.

Example 7.1.8. The method of Example 7.1.5, further comprising:
transmitting, by the SeMF, to a target RAN node of the handover, a sensing session update request message comprising the sensing continuity information; and
receiving, by the SeMF, from the target RAN node, a response to the sensing session update request message.

Example 7.1.9. The method of Example 7.1.1, wherein the notification message further comprises an indication to change SeMF to a target SeMF.

Example 7.1.10. The method of Example 7.1.1, further comprising:
determining, by the SeMF, to change SeMF to a target SeMF.

Example 7.1.11. The method of Example 7.1.9 or Example 7.1.10, further comprising:
transmitting, by the SeMF, to the target SeMF, a sensing context transfer request message; and
receiving, by the SeMF, from the target SeMF, a response to the sensing context transfer request message.

Example 7.1.13. A method comprising:
receiving, by a target sensing management function (SeMF) of a core network, from a source SeMF, a sensing context transfer request message relating to a sensing service provided by the SeMF to at least one network function of the following:
an application function, or
a network exposure function; and
transmitting, by the target SeMF, to the at least one network function, a second message indicating that target SeMF is the new provider of the sensing service.

Example 7.1.14. The method of Example 7.1.13, further comprising:
receiving, by the target SeMF, from the at least one network function, an acknowledgement of the second message; and
transmitting, by the target SeMF, to the source SeMF, a response to the sensing context transfer request message.

Example 7.1.15. The method of Example 7.1.14, further comprising:
transmitting, by the target SeMF, to an access and mobility management function (AMF), an acknowledgment of a handover notification message that was transmitted by the AMF to the source SeMF.

Example 8.1. An apparatus comprising:
means for providing, by a sensing management function (SeMF) of a core network, a sensing service, the sensing service comprising sensing service information of a source radio access network (RAN) node of a handover decision, the sensing service information comprising at least one of the following:
   at least one sensing session identifier corresponding to at least one sensing session at the source RAN node,
   a sensing resource configuration,
   a sensing session configuration, or
   a sensing data reporting configuration; and
means for receiving, by the SeMF, from an access and mobility management function (AMF) of the core network, a notification message indicating that a handover for the handover decision has occurred.

Example 8.2. The apparatus of Example 8.1, wherein the notification message comprises sensing continuity information comprising at least one of the following:
an indication of whether each of at least one sensing session was accepted or not accepted by a sensing admission control procedure,
an update for the sensing resource configuration,
an update for the sensing session configuration, or
an update for the sensing data reporting configuration.

Example 8.3. The apparatus of Example 8.1, wherein the notification message comprises the at least one sensing session identifier corresponding to the at least one sensing session at the source RAN node.

Example 8.4. The apparatus of Example 8.1, further comprising:
based on the notification message indicating that the handover for the handover decision has occurred, means for performing, by the SeMF, sensing admission control procedure.

Example 8.5. The apparatus of Example 8.4, further comprising:
means for generating, by the SeMF, based on the sensing admission control procedure, sensing continuity information comprising at least one of the following:
   an indication of whether each of at least one sensing session was accepted or not accepted by the sensing admission control procedure,
   an update for the sensing resource configuration,
   an update for the sensing session configuration, or
   an update for the sensing data reporting configuration.

Example 8.6. The apparatus of Example 8.5, further comprising:
means for transmitting, by the SeMF, to the AMF, an acknowledgment of the notification message, the acknowledgment comprising the sensing continuity information.

Example 8.7. The apparatus of Example 8.5, further comprising:
means for transmitting, by the SeMF, to a target RAN node of the handover, a sensing admission control procedure request acknowledgment message comprising the sensing continuity information.

Example 8.8. The apparatus of Example 8.5, further comprising:
means for transmitting, by the SeMF, to a target RAN node of the handover, a sensing session update request message comprising the sensing continuity information; and
means for receiving, by the SeMF, from the target RAN node, a response to the sensing session update request message.

Example 8.9. The apparatus of Example 8.1, wherein the notification message further comprises an indication to change SeMF to a target SeMF.

Example 8.10. The apparatus of Example 8.1, further comprising:
means for determining, by the SeMF, to change SeMF to a target SeMF.

Example 8.11. The apparatus of Example 8.9 or Example 8.10, further comprising:
means for transmitting, by the SeMF, to the target SeMF, a sensing context transfer request message; and
means for receiving, by the SeMF, from the target SeMF, a response to the sensing context transfer request message.

Example 8.13. An apparatus comprising:
means for receiving, by a target sensing management function (SeMF) of a core network, from a source SeMF, a sensing context transfer request message relating to a sensing service provided by the SeMF to at least one network function of the following:
   an application function, or
   a network exposure function; and
means for transmitting, by the target SeMF, to the at least one network function, a second message indicating that target SeMF is the new provider of the sensing service.

Example 8.14. The apparatus of Example 8.13, further comprising:
means for receiving, by the target SeMF, from the at least one network function, an acknowledgement of the second message; and
means for transmitting, by the target SeMF, to the source SeMF, a response to the sensing context transfer request message.

Example 8.15. The apparatus of Example 8.14, further comprising:
means for transmitting, by the target SeMF, to an access and mobility management function (AMF), an acknowledgment of a handover notification message that was transmitted by the AMF to the source SeMF.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A source radio access network (RAN) node comprising:
at least one processor; and
at least one memory storing instructions which, when executed by the at least one processor, cause the source RAN node at least to perform:
operating, by the source radio access network (RAN) node while serving a user equipment (UE), in a bistatic mode for a sensing service provided by one or more components of a core network; and
based on a handover decision that switches the UE to a target RAN node, transmitting, by the source RAN node, sensing service information to one of the following:
the target RAN node, or
an access and mobility management function (AMF) of the core network, wherein the sensing service information comprises at least one of the following:
at least one sensing session identifier corresponding to at least one sensing session for the serving service,
a sensing resource configuration for the sensing service,
a sensing session configuration for the sensing service, or
a sensing data reporting configuration for the sensing service.

2. The source RAN node according to claim 1, wherein the instructions when executed by the at least one processor, further cause the source RAN node at least to perform:
receiving, by the source RAN node, sensing continuity information comprising at least one of the following:
an indication of whether each of the at least one sensing session was accepted or not accepted by a sensing admission control procedure,
an update for the sensing resource configuration,
an update for the sensing session configuration, or
an update for the sensing data reporting configuration.

3. The source RAN node according to claim 1, wherein the transmitting the sensing service information comprises transmitting the sensing service information in a handover request message.

4. The source RAN node according to claim 3, wherein the receiving the sensing continuity information comprises receiving the sensing continuity information in a handover request acknowledgment message from the target RAN node.

5. The source RAN node according to claim 1, wherein the transmitting the sensing service information comprises transmitting the sensing service information in a message indicating that handover is required.

6. The source RAN node according to claim 5, wherein the receiving the sensing continuity information comprises receiving the sensing continuity information in a handover command message from the AMF.

7. The source RAN node according to claim 1, wherein the instructions when executed by the at least one processor, further cause the source RAN node at least to perform:
buffering sensed data from the operating in the bistatic mode; and
transmitting the sensed data to the target RAN node.

8. A method comprising:
operating, by a source radio access network (RAN) node serving a user equipment (UE), in a bistatic mode for a sensing service provided by one or more components of a core network; and
based on a handover decision that switches the UE to a target RAN node, transmitting, by the source RAN node, sensing service information to one of the following:
the target RAN node, or
an access and mobility management function (AMF) of the core network, wherein the sensing service information comprises at least one of the following:
at least one sensing session identifier corresponding to at least one sensing session for the serving service,
a sensing resource configuration for the sensing service,
a sensing session configuration for the sensing service, or
a sensing data reporting configuration for the sensing service.

9. A target radio access network (RAN) node comprising:
at least one processor; and
at least one memory storing instructions which, when executed by the at least one processor, cause the target RAN node at least to perform:
receiving, by the target radio access network (RAN) node of a handover decision, sensing service information for a sensing service, the sensing service provided by one or more components of a core network, the sensing service information comprising at least one of the following:
at least one sensing session identifier corresponding to at least one sensing session of a source RAN node of the handover decision,
a sensing resource configuration,
a sensing session configuration, or
a sensing data reporting configuration; and
operating, by the target RAN node, in a bistatic mode for the sensing service.

10. The target RAN node according to claim 9, wherein the instructions, when executed by the at least one processor, further cause the target RAN node at least to perform:
performing, by the target RAN node, sensing admission control procedure based on the sensing service information.

11. The target RAN node according to claim 10, wherein the instructions, when executed by the at least one processor, further cause the target RAN node at least to perform:
generating, by the target RAN node, based on the sensing admission control procedure, sensing continuity information comprising at least one of the following:
an indication of whether each of the at least one sensing session was accepted or not accepted by the sensing admission control procedure,
an update for the sensing resource configuration,
an update for the sensing session configuration, or
an update for the sensing data reporting configuration; and
transmitting, by the target RAN node, the sensing continuity information.

12. The target RAN node according to claim 11,
wherein the receiving the sensing service information comprises receiving, from the source RAN node, the sensing service information in a handover request message, and
wherein the transmitting the sensing continuity information comprises transmitting, to the source RAN node, the sensing continuity information in a handover request acknowledgment message.

13. The target RAN node according to claim 11,
wherein the receiving the sensing service information comprises receiving, from an access and mobility management function (AMF) of the core network, the sensing service information in a handover request message, and
wherein the transmitting the sensing continuity information comprises transmitting, to the AMF, the sensing continuity information in a handover request acknowledgment message.

14. The target RAN node according to claim 13, wherein the AMF is a target AMF in case of an AMF relocation due to handover.

15. The target RAN node according to claim 11, wherein the instructions, when executed by the at least one processor, further cause the target RAN node at least to perform:
transmitting, by the target RAN node, to an access and mobility management function (AMF) of the core network, a path switch request message comprising the sensing continuity information.

16. The target RAN node according to claim 9, wherein the instructions, when executed by the at least one processor, further cause the target RAN node at least to perform:
transmitting, by the target RAN node, to an access and mobility management function (AMF) of the core network, a path switch request message comprising the sensing service information; and
receiving, by the target RAN node, from the AMF, a path switch request acknowledgment message comprising sensing continuity information, the sensing continuity information comprising at least one of the following:
an indication of whether each of the at least one sensing session was accepted or not accepted by a sensing admission control procedure,
an update for the sensing resource configuration,
an update for the sensing session configuration, or
an update for the sensing data reporting configuration.

17. The target RAN node according to claim 9, wherein the instructions, when executed by the at least one processor, further cause the target RAN node at least to perform:
receiving, by the target RAN node, from a sensing management function (SeMF) of the one or more components of the core network, a sensing admission control procedure request acknowledgment message comprising sensing continuity information, the sensing continuity information comprising at least one of the following:
an indication of whether each of the at least one sensing session was accepted or not accepted by a sensing admission control procedure,
an update for the sensing resource configuration,
an update for the sensing session configuration, or
an update for the sensing data reporting configuration.

18. The target RAN node according to claim 9, wherein the instructions, when executed by the at least one processor, further cause the target RAN node at least to perform:
transmitting, by the target RAN node, to an access and mobility management function (AMF) of the core network, a handover execution notification message comprising the sensing service information.

19. The target RAN node according to claim 9, wherein the instructions, when executed by the at least one processor, further cause the target RAN node at least to perform:
receiving, by the target RAN node, from a sensing management function (SeMF) of the one or more components of the core network, a sensing session update request message comprising the sensing continuity information, the sensing continuity information comprising an indication of whether each of the at least one sensing session was accepted or not accepted by a sensing admission control procedure;
transmitting, by the target RAN node, to a user equipment (UE) served by the target RAN node, a reconfiguration of UE sensing configuration message;
receiving, by the target RAN node, from the UE, a response to the reconfiguration of UE sensing configuration message; and
transmitting, by the target RAN node, to the SeMF, a response to the sensing session update request message.

20. The target RAN node according to claim 9, wherein the instructions, when executed by the at least one processor, further cause the target RAN node at least to perform:
receiving, from the source RAN node, sensed data buffered by the source RAN node.

21. A method comprising:
receiving, by a target radio access network (RAN) node of a handover decision, sensing service information for a sensing service, the sensing service provided by one or more components of a core network, the sensing service information comprising at least one of the following:
at least one sensing session identifier corresponding to at least one sensing session of a source RAN node of the handover decision,
a sensing resource configuration,
a sensing session configuration, or
a sensing data reporting configuration; and
operating, by the target RAN node, in a bistatic mode for the sensing service.
